(19) United States
(12) Patent Application Publication
(10) Pub. No.: US 2017/0315644 A1
(43) Pub. Date: Nov. 2, 2017

(54) DISPLAY DEVICE, INPUT/OUTPUT DEVICE, DATA PROCESSING DEVICE, AND DISPLAY METHOD

(71) Applicant: SEMICONDUCTOR ENERGY LABORATORY CO., LTD., Atsugi-shi (JP)

(72) Inventor: Masahiko HAYAKAWA, Atsugi (JP)

(21) Appl. No.: 15/491,105

(22) Filed: Apr. 19, 2017

(30) Foreign Application Priority Data
Apr. 28, 2016 (JP) 2016-090847
Apr. 28, 2016 (JP) 2016-090848
May 11, 2016 (JP) 2016-095071

(51) Int. Cl. G06F 3/041; G09G 3/20

(52) U.S. Cl. CPC G06F 3/0412; G06F 3/0416; G09G 3/2092

(57) ABSTRACT

A display device is provided. An input/output device is provided. A data processing device is provided. A display method is provided. The display device includes a display panel and a control portion. The control portion has a function of receiving image data and control data, a function of generating first data on the basis of the image data, a function of generating second data on the basis of the image data, a function of detecting a contour portion from the image data, a function of generating third data in which the contour portion is emphasized, and a function of supplying the first to third data. The display panel has a function of receiving the first to third data and includes a pixel. The pixel includes a first display element and a second display element. The first display element has a function of displaying an image on the basis of the first data, and the second display element has a function of displaying an image on the basis of the second or third data.

### TECHNICAL FIELD

One embodiment of the present invention relates to a display device, an input/output device, a data processing device, a display method, or a semiconductor device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Specifically, examples of the technical field of one embodiment of the present invention disclosed in this specification include a semiconductor device, a display device, a light-emitting device, a power storage device, a memory device, a method for driving any of them, and a method for manufacturing any of them.

### BACKGROUND ART

A liquid crystal display device in which a light-condensing means and a pixel electrode are provided on the same surface side of a substrate and a region transmitting visible light in the pixel electrode is provided to overlap with an optical axis of the light-condensing means, and a liquid crystal display device which includes an anisotropic light-condensing means having a condensing direction X and a non-condensing direction Y that is along a longitudinal direction of a region transmitting visible light in the pixel electrode are known (Patent Document 1).

### REFERENCE

### Patent Document

[Patent Document 1] Japanese Published Patent Application No. 2011-191750

### DISCLOSURE OF INVENTION

An object of one embodiment of the present invention is to provide a novel display device with high convenience or high reliability. Another object is to provide a novel input/output device with high convenience or high reliability. Another object is to provide a novel data processing device with high convenience or high reliability. Another object is to provide a novel display method with high convenience or high reliability. Another object is to provide a novel display device, a novel input/output device, a novel data processing device, a novel display method, or a novel semiconductor device.

The description of these objects does not disturb the existence of other objects. In one embodiment of the present invention, there is no need to achieve all the objects. Other objects will be apparent from and can be derived from the description of the specification, the drawings, the claims, and the like.

(1)

One embodiment of the present invention is a display device including a display panel and a control portion.

The control portion is configured to receive an image data and a control data. The control portion is configured to generate a first data on the basis of the image data and to generate a second data on the basis of the image data. The control portion is configured to detect a contour portion from the image data and to generate a third data where the contour portion is emphasized. The control portion is configured to supply the first to third data.

The display panel is configured to receive the first to third data. The display panel includes a pixel.

The pixel includes a first display element and a second display element. The first display element is configured to display an image on the basis of the first data. The second display element is configured to display an image on the basis of the second data or the third data.

Thus, text data can be displayed with an increase in the visibility as compared with a case using only the first display element. Alternatively, a schematic diagram can be displayed with an increase in the visibility as compared with a case using only the first display element. Alternatively, a sharp and clear image can be displayed as compared with a case using only the first display element. Consequently, a novel display device with high convenience or high reliability can be provided.

(2)

Another embodiment of the present invention is the above display device where the first display element is a reflective display element, and the second display element is a light-emitting element.

Thus, an image with a high contrast ratio can be displayed with low power consumption as compared with a case using only the second display element. An image with a high contrast ratio can be displayed while a reduction in the reliability of the second display element is suppressed as compared with a case using only the second display element. Alternatively, the text data can be displayed with an increase in the visibility as compared with a case using only the first display element. Alternatively, a schematic diagram can be displayed with an increase in the visibility as compared with a case using only the first display element. Alternatively, a sharp and clear image can be displayed as compared with a case using only the first display element. Consequently, a novel display device with high convenience or high reliability can be provided.

(3)

Another embodiment of the present invention is the above-described display device where the pixel includes a first conductive film, a second conductive film, an insulating film, a pixel circuit, the first display element, and the second display element.

The second conductive film has a region overlapping with the first conductive film.

The insulating film has a region sandwiched between the first conductive film and the second conductive film. The insulating film has an opening.

The second conductive film is electrically connected to the first conductive film in the opening. The second conductive film is electrically connected to the pixel circuit.

The first conductive film is electrically connected to the first display element.

The second display element is electrically connected to the pixel circuit and configured to emit light toward the insulating film. The second display element is located so that an image displayed using the second display element can be seen in a part of a range where an image displayed using the first display element is seen.

(4)

Another embodiment of the present invention is the display device where the display panel includes one group of a plurality of pixels, another group of a plurality of pixels, a signal line, and a scan line.

The one group of a plurality of pixels includes the pixel and are arranged in a row direction.

The another group of a plurality of pixels includes the pixel and are arranged in a column direction intersecting the row direction.

The scan line is electrically connected to the one group of a plurality of pixels, and the signal line is electrically connected to the another group of a plurality of pixels.

Accordingly, the first display element and the second display element which perform display using different methods can be driven, for example, with the pixel circuit which can be formed in the same process. Specifically, a reflective display element is used as the first display element, whereby the power consumption can be reduced. Alternatively, an image can be favorably displayed in an environment with bright external light. Alternatively, the second display element which emits light is used, whereby an image can be favorably displayed in a dark environment. Alternatively, using the insulating film, impurity diffusion between the first display element and the second display element or between the first display element and the pixel circuit can be suppressed. Consequently, a novel display device with high convenience or high reliability can be provided.

(5)

Another embodiment of the present invention is an input/output device including the above-described display device and an input portion. The input portion is configured to sense an object approaching a region which overlaps with the display panel.

Thus, the object approaching the region overlapping with the display device can be sensed while the image data is displayed by the display device. As a result, a novel input/output device with high convenience or high reliability can be provided.

(6)

Another embodiment of the present invention is the above-described input/output device where the input portion has a region overlapping with the display panel and includes a control line, a sensor signal line, and a sensor element.

The control line is configured to supply a control signal. The sensor signal line is configured to receive a sensor signal.

The sensor element is electrically connected to the control line and the sensor signal line. The sensor element has a light-transmitting property and includes a first electrode and a second electrode.

The first electrode is electrically connected to the control line, and the second electrode is electrically connected to the sensor signal line.

The second electrode is located so that an electric field part of which is blocked by the object approaching the region overlapping with the display panel is generated between the second electrode and the first electrode.

The sensor element is configured to supply a sensor signal that changes depending on a control signal and a distance between the sensor element and an object approaching the region overlapping with the display panel.

Thus, a finger or the like approaching the region overlapping with the display device can be sensed while the image data is displayed by the display device. As a result, a novel input/output device with high convenience or high reliability can be provided.

(7)

Another embodiment of the present invention is a data processing device including an input/output device and an arithmetic device.

The input/output device includes an input portion and an output portion. The output portion includes the above-described display device, and the input portion is configured to supply a positional data.

The arithmetic device is configured to supply an image data and to supply a control signal on the basis of the positional data.

The control portion is configured to generate a first, second or third data on the basis of the control signal.

Thus, a user of the data processing device can select a display method. Specifically, when a display method in which the first display element is used is selected, power consumption can be suppressed, for example. Alternatively, when a display method in which the second display element is used is selected, an image can be displayed in a dark place, for example. Alternatively, when a display method in which the first display element and the second display element are used is selected, text data can be displayed with an increase in the visibility as compared with the case of using only the first display element. Alternatively, when a display method in which the first display element and the second display element are used is selected, a schematic diagram can be displayed with an increase in the visibility as compared with the case of using only the first display element. Alternatively, when a display method in which the first display element and the second display element are used is selected, a sharp and clear image can be displayed as compared with the case of using only the first display element. As a result, a novel data processing device with high convenience or high reliability can be provided.

(8)

Another embodiment of the present invention is a method for displaying an image data of a data processing device, including a main processing and an interrupt processing.

The main processing includes a first step to a fifth step.

In the first step, a setting is initialized.

In the second step, an interrupt processing is allowed.

In the third step, an image is displayed with a display method that is selected in the first step or the interrupt processing.

In the fourth step, the processing is determined to proceed to the fifth step when a termination instruction is supplied, whereas the processing is determined to proceed to the third step when the termination instruction is not supplied.

In the fifth step, the main processing terminates.

The interrupt processing includes a sixth step to a fourteenth step.

In the sixth step, a display method is selected.

In the seventh step, the processing is determined to proceed to the eighth step when a first display method is selected, whereas the processing is determined to proceed to the ninth step when the first display method is not selected.

In the eighth step, a second data is generated on the basis of the image data, and the processing proceeds to the thirteenth step.

In the ninth step, a first data is generated on the basis of the image data.

In the tenth step, the processing is determined to proceed to the eleventh step when a second display method is selected, whereas the processing is determined to proceed to the thirteenth step when the second display method is not selected.

In the eleventh step, a contour portion is detected from the image data.

In the twelfth step, a third data in which the contour portion is emphasized is generated.

In the thirteenth step, the generated data is supplied.

In the fourteenth step, the interrupt processing terminates.

Thus, a user of the data processing device can select a display method. Specifically, when a display method in which the first display element is used is selected, power consumption can be suppressed, for example. Alternatively, when a display method in which the second display element is used is selected, an image can be displayed in a dark place, for example. Alternatively, when a display method in which the first display element and the second display element are used is selected, text data can be displayed with an increase in the visibility as compared with the case of using only the first display element. Alternatively, when a display method in which the first display element and the second display element are used is selected, a schematic diagram can be displayed with an increase in the visibility as compared with the case of using only the first display element. Alternatively, when a display method in which the first display element and the second display element are used is selected, a sharp and clear image can be displayed as compared with the case of using only the first display element. As a result, a novel display method of an image data of a data processing device with high convenience or high reliability can be provided.

(9)

Another embodiment of the present invention is a data processing device including at least one of a keyboard, a hardware button, a pointing device, a touch sensor, an illuminance sensor, an imaging device, an audio input device, a viewpoint input device, and a posture determination device, and the above-described display device.

Thus, the arithmetic device can generate the image data or the control data on the basis of the data which is supplied using a variety of input devices. In addition, with the generated image data or control data, the power consumption can be reduced. Moreover, display with high visibility can be performed even in a bright place. As a result, a novel data processing device with high convenience or high reliability can be provided.

(10)

Another embodiment of the present invention is a display device including a display panel and a control portion.

The control portion is configured to receive an image data and an annotation data. The control portion is configured to generate a first data on the basis of the image data and a second data on the basis of the annotation data. In addition, the control portion is configured to supply the first data and the second data.

The display panel is configured to receive the first data and the second data. The display panel includes a pixel.

The pixel includes a first display element and a second display element. The first display element is configured to display an image on the basis of the first data, and the second display element is configured to display an image on the basis of the second data.

Thus, the annotation data can be displayed with use of the second display element to overlap with the image data displayed with use of the first display element. Alternatively, the annotation data can be displayed to overlap with the image data without an integration of the image data and the annotation data. Alternatively, the annotation data can be displayed to overlap with the image data concurrently with generation of the annotation data that is not integrated with the image data. Alternatively, power consumption caused by arithmetic processing can be reduced. Consequently, a novel display device with high convenience or high reliability can be provided.

(11)

Another embodiment of the present invention is the above-described display device where the first display element is a reflective display element and the second display element is a light-emitting element.

Thus, power consumed in displaying the image data by the first display element can be reduced. Alternatively, the annotation data displayed with use of the second display element to overlap with the image data can be discriminated from the image data. Consequently, a novel display device with high convenience or high reliability can be provided.

(12)

Another embodiment of the present invention is a data processing device including an input/output device and an arithmetic device.

The input/output device includes an input portion and an output portion. The output portion includes the above-described display device, and the input portion is configured to supply a positional data.

The arithmetic device is configured to generate an annotation data on the basis of the positional data and supply an image data and the annotation data.

The arithmetic device is configured to integrate the image data and the annotation data to update the image data. In addition, the arithmetic device is configured to store the image data.

Thus, the data processing device can generate the annotation data on the basis of the positional data supplied by a user of the data processing device, for example. Alternatively, the data processing device can display the annotation data. Alternatively, the data processing device can add the generated annotation data to the image data. Consequently, a novel data processing device with high convenience or high reliability can be provided.

(13)

Another embodiment of the present invention is a method for displaying an image data of a data processing device, including a main processing, a first interrupt processing, and a second interrupt processing.

The main processing includes a first step to a fifth step.

In the first step, the setting is initialized.

In a second step, the interrupt processing is allowed.

In the third step, an image is displayed by a display method selected in the first step or the interrupt processing.

In the fourth step, the processing is determined to proceed to the fifth step when a termination instruction is supplied, whereas the processing is determined to proceed to the third step when the termination instruction is not supplied.

In the fifth step, the interrupt processing terminates.

The first interrupt processing includes a sixth step to a fourteenth step.

In the sixth step, the processing is determined to proceed to the seventh step when a predetermined event is supplied, whereas the processing is determined to proceed to the fourteenth step when the predetermined event is not supplied.

In the seventh step, an annotation adding mode is changed.

In the eighth step, the processing is determined to proceed to the ninth step when the annotation adding mode is selected, whereas the processing is determined to proceed to the eleventh step when the annotation adding mode is not selected.

In the ninth step, a first data is generated on the basis of an image data.

In the tenth step, the first data is supplied.

In the eleventh step, the processing is determined to proceed to the twelfth step when the annotation data is generated, whereas the processing is determined to proceed to the fourteenth step when the annotation data is not generated.

In the twelfth step, the image data is updated by integration with the annotation data.

In the thirteenth step, the image data is stored, and the processing proceeds to the ninth step.

In the fourteenth step, the first interrupt processing terminates.

The second interrupt processing includes a fifteenth step to a twentieth step.

In the fifteenth step, the processing is determined to proceed to the sixteenth step when a predetermined event is supplied, whereas the processing is determined to proceed to the twentieth step when the predetermined event is not supplied.

In the sixteenth step, the processing is determined to proceed to the seventeenth step when the annotation adding mode is selected, whereas the processing is determined to proceed to the twentieth step when the annotation adding mode is not selected.

In the seventeenth step, an annotation data is generated on the basis of the event.

In the eighteenth step, a second data is generated on the basis of the annotation data.

In the nineteenth step, the second data is supplied.

In the twentieth step, the second interrupt processing terminates.

Thus, the data processing device can generate an annotation data on the basis of an event supplied by a user of the data processing device, for example. Alternatively, the data processing device can display the annotation data. Alternatively, the generated annotation data can be added to an image data. Consequently, a novel method for displaying an image data and adding an annotation of a data processing device with high convenience or high reliability can be provided.

(14)

Another embodiment of the present invention is a display device including a display panel and a control portion.

The control portion is configured to receive a first image data, a second image data, and a region data.

The control portion is configured to store the first image data.

The control portion is configured to synthesize the image data on the basis of the first image data, the second image data, and the region data.

The control portion is configured to supply the first data and the second data on the basis of the image data.

The display panel is configured to receive the first data and the second data and includes a pixel.

The pixel includes a first display element and a second display element. The first display element is configured to display an image on the basis of the first data, and the second display element is configured to display an image on the basis of the second data.

Thus, a predetermined region can be set with use of the region data. Alternatively, a range affected by a predetermined instruction can be set with use of the region data. Alternatively, the second image data including a predetermined region affected by the predetermined instruction can be generated. Alternatively, the first image data can be stored. Alternatively, a predetermined region of the second image data is embedded in a predetermined region of the first image data, so that an image data can be synthesized. Alternatively, the synthesized image data can be displayed. Consequently, a novel display device with high convenience or high reliability can be provided.

(15)

Another embodiment of the present invention is the above-described display device where the first display element is a reflective display element and the second display element is a light-emitting element.

Thus, the power consumed in displaying the image data by the first display element can be reduced. Consequently, a novel display device with high convenience or high reliability can be provided.

(16)

Another embodiment of the present invention is a data processing device including an input/output device and an arithmetic device.

The input/output device includes an input portion and an output portion. The output portion includes the above-described display device, and the input portion is configured to supply a positional data.

The arithmetic device is configured to supply a first image data, a second image data, and a region data.

The arithmetic device is configured to generate a second image data on the basis of the positional data.

The arithmetic device is configured to generate the region data on the basis of the positional data.

Thus, the data processing device can generate the region data on the basis of the positional data supplied by a user of the data processing device, for example. Alternatively, the data processing device can generate the second image data. Consequently, a novel data processing device with high convenience or high reliability can be provided.

(17)

Another embodiment of the present invention is a method for displaying an image data of a data processing device, including a main processing, a first interrupt processing, and a second interrupt processing.

The main processing includes a first step to a fifth step.

In the first step, a setting is initialized.

In a second step, the interrupt processing is allowed.

In the third step, an image data is displayed by a display method selected in the first step or the interrupt processing.

In the fourth step, the processing is determined to proceed to the fifth step when a termination instruction is supplied, whereas the processing is determined to proceed to the third step when the termination instruction is not supplied.

In the fifth step, the interrupt processing terminates.

The first interrupt processing includes a sixth step to a sixteenth step, and the second interrupt processing includes a seventeenth step to a twenty-second step.

In the sixth step, the processing is determined to proceed to the seventh step when a predetermined event is supplied, whereas the processing is determined to proceed to the sixteenth step when the predetermined event is not supplied.

In the seventh step, a region mode is changed. Note that the sentence “a region mode is changed” refers to setting a region mode or canceling a region mode.

In the eighth step, the processing is determined to proceed to the ninth step when the region mode is selected, whereas the processing is determined to proceed to the thirteenth step when the region mode is not selected.

In the ninth step, a parameter for display is stored.

In the tenth step, a region is selected.

In the eleventh step, a first image data is stored.

In the twelfth step, a range affected by a predetermined instruction is restricted to the region.

In the thirteenth step, the parameter for display is read out.

In the fourteenth step, the image data is generated.

In the fifteenth step, the restriction on the range affected by the predetermined instruction is removed.

In the sixteenth step, the first interrupt processing terminates.

In the seventeenth step, the processing is determined to proceed to the eighteenth step when a predetermined event is supplied, whereas the processing is determined to proceed to the twenty-second step when the predetermined event is not supplied.

In the eighteenth step, the processing is determined to proceed to the nineteenth step when the region mode is selected, whereas the processing is determined to proceed to the twenty-second step when the region mode is not selected.

In the nineteenth step, the predetermined instruction associated with the predetermined event is executed.

In the twentieth step, a second image data is generated.

In the twenty-first step, a predetermined region of the second image data is embedded in a predetermined region of the first image data, so that an image data can be synthesized.

In the twenty-second step, the second interrupt processing terminates.

Thus, the data processing device can set the predetermined region on the basis of the event supplied by a user of the data processing device, for example. Alternatively, the data processing device can restrict a range affected by the predetermined instruction to the predetermined region. Alternatively, a range affected by an instruction such as an instruction for changing a parameter for display, an instruction for editing data to be displayed, or an instruction for changing a format of data to be displayed can be restricted to the predetermined region. Consequently, a novel method for displaying an image data of a data processing device with high convenience or high reliability can be provided.

(18)

Another embodiment of the present invention is a method for displaying an image data of a data processing device, including a main processing and an interrupt processing.

The main processing includes a step in which the interrupt processing is allowed and a step in which an image is displayed.

The interrupt processing includes a step in which a first region-setting mode or a second region-setting mode is selected.

The first region-setting mode includes a step in which one or a plurality of regions are selected and a step in which a display luminance, a display size, or a display position of the region is determined.

The second region-setting mode includes a step in which one or a plurality of regions are selected, a step in which a display luminance, a display size, or a display position of the region is selected, a step in which a shape or a size of the region is determined, and a step in which the setting is canceled.

Although the block diagram attached to this specification shows components classified by their functions in independent blocks, it is difficult to classify actual components according to their functions completely and it is possible for one component to have a plurality of functions.

In this specification, the terms “source” and “drain” of a transistor interchange with each other depending on the polarity of the transistor or the levels of potentials applied to the terminals. In general, in an n-channel transistor, a terminal to which a lower potential is applied is called a source, and a terminal to which a higher potential is applied is called a drain. In a p-channel transistor, a terminal to which a lower potential is applied is called a drain, and a terminal to which a higher potential is applied is called a source. In this specification, although connection relation of the transistor is described assuming that the source and the drain are fixed for convenience in some cases, actually, the names of the source and the drain interchange with each other depending on the relation of the potentials.

Note that in this specification, a “source” of a transistor means a source region that is part of a semiconductor film functioning as an active layer or a source electrode connected to the semiconductor film. Similarly, a “drain” of a transistor means a drain region that is part of the semiconductor film or a drain electrode connected to the semiconductor film. A “gate” means a gate electrode.

Note that in this specification, a state in which transistors are connected to each other in series means, for example, a state in which only one of a source and a drain of a first transistor is connected to only one of a source and a drain of a second transistor. In addition, a state in which transistors are connected in parallel means a state in which one of a source and a drain of a first transistor is connected to one of a source and a drain of a second transistor and the other of the source and the drain of the first transistor is connected to the other of the source and the drain of the second transistor.

In this specification, the term “connection” means electrical connection and corresponds to a state where a current, a voltage, or a potential can be supplied or transmitted. Accordingly, connection means not only direct connection but also indirect connection through a circuit element such as a wiring, a resistor, a diode, or a transistor so that a current, a potential, or a voltage can be supplied or transmitted.

In this specification, even when different components are connected to each other in a circuit diagram, there is actually a case where one conductive film has functions of a plurality of components such as a case where part of a wiring serves as an electrode. The term “connection” in this specification also means such a case where one conductive film has functions of a plurality of components.

Further, in this specification, one of a first electrode and a second electrode of a transistor refers to a source electrode and the other refers to a drain electrode.

According to one embodiment of the present invention, a novel display device with high convenience or high reliability can be provided. Alternatively, a novel input/output device with high convenience or high reliability can be provided. Alternatively, a novel data processing device with high convenience or high reliability can be provided. Alternatively, a novel display method with high convenience or high reliability can be provided. Alternatively, a novel input/output device, a novel data processing device, a novel display method, or a novel semiconductor device can be provided.

Note that the description of these effects does not preclude the existence of other effects. One embodiment of the present invention does not necessarily have all the effects. Other effects are apparent from and can be derived from the description of the specification, the drawings, the claims, and the like.

### BRIEF DESCRIPTION OF THE DRAWINGS

FIG. 1 is a block diagram illustrating a structure of a display device of one embodiment.

FIG. 2 is a block diagram illustrating a structure of a display portion in a data processing device of one embodiment.

FIGS. 3A to 3C illustrate a structure of a display panel that can be used for a display device of one embodiment.

FIGS. 4A and 4B are cross-sectional views illustrating a structure of a display panel that can be used for a display device of one embodiment.

FIGS. 5A and 5B are cross-sectional views illustrating a structure of a display panel that can be used for a display device of one embodiment.

FIGS. 6A and 6B are bottom views illustrating a structure of a display panel that can be used for a display device of one embodiment.

FIG. 7 is a circuit diagram illustrating a pixel circuit of a display panel that can be used for a display device of one embodiment.

FIGS. 8A to 8C are schematic views illustrating a shape of a reflective film of a pixel that can be used for a display device of one embodiment.

FIG. 9 is a block diagram illustrating a structure of an input portion that can be used for an input/output device of one embodiment.

FIGS. 10A to 10C illustrate a structure of an input/output panel that can be used for an input/output device of one embodiment.

FIGS. 11A and 11B are cross-sectional views illustrating a structure of an input/output panel that can be used for an input/output device of one embodiment.

FIG. 12 is a cross-sectional view illustrating a structure of an input/output panel that can be used for an input/output device of one embodiment.

FIGS. 13A to 13C are a block diagram illustrating a structure of a data processing device of one embodiment and projection views each illustrating an external view of the data processing device.

FIGS. 14A and 14B are flow charts showing a driving method of a data processing device of one embodiment.

FIG. 15 is a flow chart showing a driving method of a data processing device of one embodiment.

FIG. 16 is a flow chart showing a driving method of a data processing device of one embodiment.

FIG. 17 is a flow chart showing a driving method of a data processing device of one embodiment.

FIG. 18 is a flow chart showing a driving method of a data processing device of one embodiment.

FIG. 19 is a flow chart showing a driving method of a data processing device of one embodiment.

FIG. 20 is a flow chart showing a driving method of a data processing device of one embodiment.

FIG. 21 is a flow chart showing a driving method of a data processing device of one embodiment.

FIG. 22 is a flow chart showing a driving method of a data processing device of one embodiment.

FIG. 23 is a flow chart showing a driving method of a data processing device of one embodiment.

FIGS. 24A to 24F are schematic views each illustrating a display state where a part including a character string or the like to be subjected to a predetermined operation of one embodiment is enlarged and the other part is not enlarged.

FIGS. 25A to 25H each illustrate a structure of an electronic device of one embodiment.

### BEST MODE FOR CARRYING OUT THE INVENTION

One embodiment of the present invention is a display device including a display panel and a control portion.

The control portion has a function of receiving image data and control data, a function of generating first data on the basis of the image data, a function of generating second data on the basis of the image data, a function of detecting a contour portion from the image data, a function of generating third data in which the contour portion is emphasized, and a function of supplying the first to third data.

The display panel has a function of receiving the first to third data and includes a pixel.

The pixel includes a first display element and a second display element.

The first display element has a function of displaying an image on the basis of the first data, and the second display element has a function of displaying an image on the basis of the second data or the third data.

Thus, text data can be displayed with an increase in the visibility as compared with the case of using only the first display element. Alternatively, a schematic diagram can be displayed with an increase in the visibility as compared with the case of using only the first display element. Alternatively, a sharp and clear image can be displayed as compared with the case of using only the first display element. Consequently, a novel display device with high convenience or high reliability can be provided.

Embodiments will be described in detail with reference to the drawings. Note that the present invention is not limited to the following description. It will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and a description thereof is not repeated.

### Embodiment 1

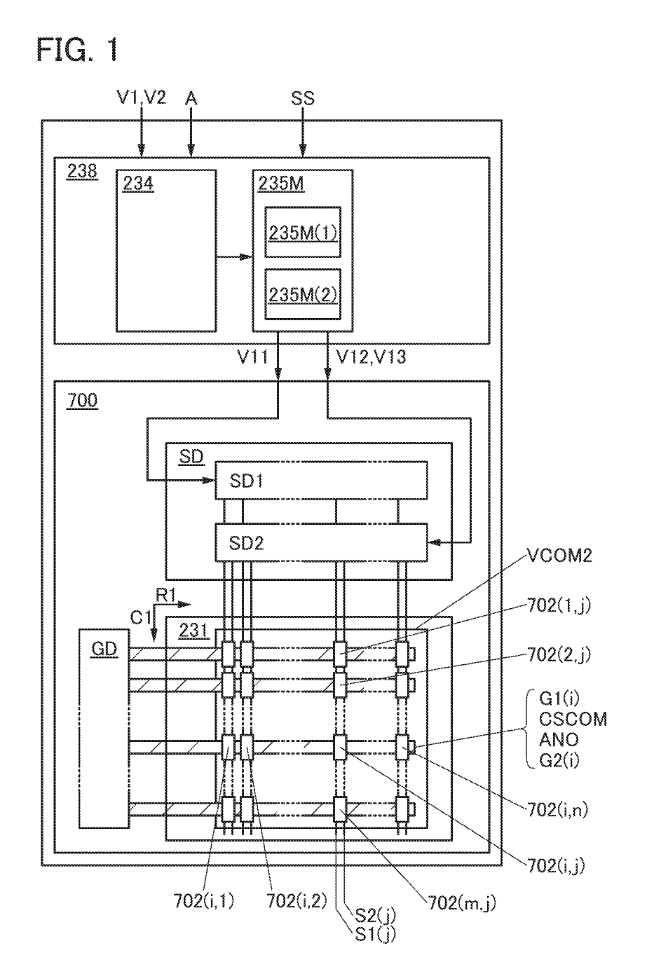

In this embodiment, a structure of a display device of one embodiment of the present invention will be described with reference to FIG. 1.

FIG. 1 is a block diagram illustrating a structure of a display device of one embodiment of the present invention.

### <Structure Example 1 of Display Device>

A display device described in this embodiment includes a display panel 700 and a control portion 238 (see FIG. 1).

### <<Control Portion 238>>

The control portion 238 has a function of receiving image data V1 and control data SS.

The control portion 238 has a function of generating first data V11 on the basis of the image data V1, and the control portion 238 has a function of generating second data V12 on the basis of the image data V1.

The control portion 238 has a function of detecting a contour portion from the image data and a function of generating third data V13 in which the contour portion is emphasized. The control portion 238 has a function of supplying the first data V11 to the third data V13.

For example, the control portion 238 includes a decompression circuit 234 and an image processing circuit 235M.

### <<Display Panel 700>>

The display panel 700 has a function of receiving the first data V11 to the third data V13. The display panel 700 includes a pixel 702(i,j).

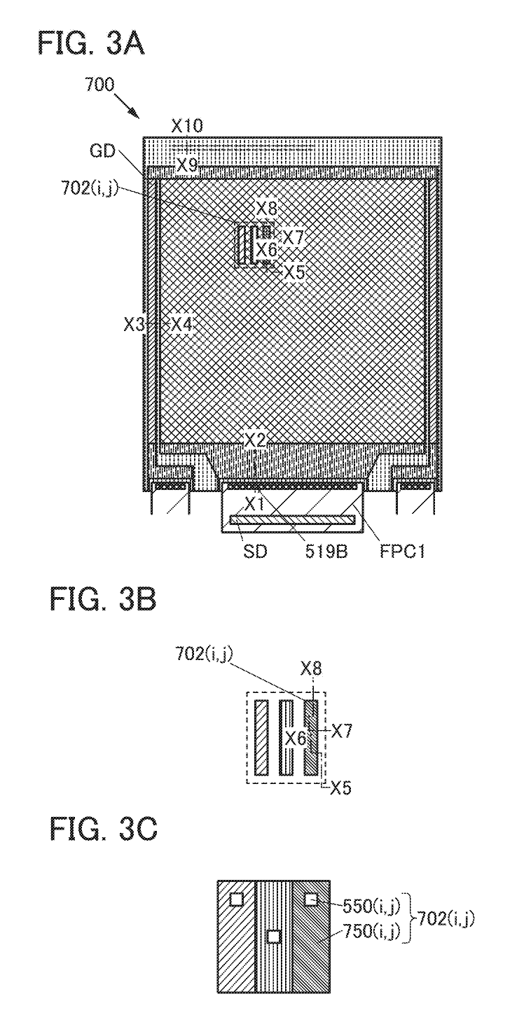

The pixel 702(i,j) includes a first display element 750(i,j) and a second display element 550(i,j) (see FIG. 3C).

The first display element 750(i,j) has a function of displaying an image on the basis of the first data V11, and the second display element 550(i,j) has a function of displaying an image on the basis of the second data V12 or the third data V13.

For example, a display panel described in Embodiment 2 can be used for the display panel 700. For example, a display element which can express a wider color gamut than a color gamut that can be expressed by the first display element 750(i,j) can be used for the second display element 550(i,j). Specifically, as the second display element, an organic EL element can be used, which can express a wider color gamut than a color gamut that can be expressed by a reflective liquid crystal element used as the first display element 750(i,j).

Thus, the text data can be displayed with an increase in the visibility as compared with the case of using only the first display element. Alternatively, a schematic diagram can be displayed with an increase in the visibility as compared with the case of using only the first display element. Alternatively, a sharp and clear image can be displayed as compared with the case of using only the first display element. Alternatively, a vividly colored image can be displayed as compared with the case of using only the first display element. Consequently, a novel display device with high convenience or high reliability can be provided.

For example, a reflective liquid crystal display element can be used as the first display element 750(i,j). Alternatively, a light-emitting element can be used as the second display element 550(i,j).

Thus, an image with a high contrast ratio can be displayed with low power consumption as compared with the case of using only the second display element. Alternatively, an image with a high contrast ratio can be displayed while a reduction in reliability of the second display element is suppressed as compared with the case of using only the second display element. Alternatively, the text data can be displayed with an increase in the visibility as compared with the case of using only the first display element. Alternatively, a schematic diagram can be displayed with an increase in the visibility as compared with the case of using only the first display element. Alternatively, a sharp and clear image can be displayed as compared with the case of using only the first display element. Consequently, a novel display device with high convenience or high reliability can be provided.

### <<Decompression Circuit 234>>

The decompression circuit 234 has a function of decompressing the image data V1 that is received in a compressed state. The decompression circuit 234 includes a memory portion. The memory portion has a function of storing the decompressed image data, for example.

### <<Image Processing Circuit 235M>>

The image processing circuit 235M has a function of correcting the image data V1 on the basis of a predetermined characteristic curve to generate data V11 and a function of supplying the data V11. Specifically, the image processing circuit 235M has a function of generating the data V11 so that the first display element displays a favorable image. Note that a reflective liquid crystal element can be used as the first display element, for example.

The image processing circuit 235M has a function of correcting the image data V1 on the basis of a predetermined characteristic curve to generate data V12 and a function of supplying the data V12. Specifically, the image processing circuit 235M has a function of generating the data V12 so that the second display element displays a favorable image. Note that an organic EL element can be used as the second display element.

The image processing circuit 235M, for example, has a function of detecting a contour portion of an image from the image data V1, a function of generating data V13 in which the contour portion is emphasized, and a function of supplying the data V13. Specifically, the image processing circuit 235M has a function of supplying the data V13 in which a contrast of the contour portion with respect to the other part is emphasized.

The image processing circuit 235M includes a memory portion. The memory portion has a function of storing, for example, the image data in which the contour portion is emphasized, a reference table used for emphasis of the contour portion, or the like.

For example, a known technique can be used for the detecting of the contour portion. Specifically, a Canny edge detection method can be used for the detection of the contour portion. Alternatively, a method in which a region including a pixel exceeding a predetermined threshold is determined as the contour portion can be used. Further alternatively, a method in which a region where a difference between pixels exceeds a predetermined threshold is determined as the contour portion.

### <Structure Example 2 of Display Device>

A display device described in this embodiment includes the display panel 700 and the control portion 238 (see FIG. 1).

### <<Control Portion 238>>

The control portion 238 has a function of receiving the image data V1 and image data V2 including annotation data.

The control portion 238 has a function of generating the first data V11 on the basis of the image data V1. The control portion 238 has a function of generating the second data V12 on the basis of the image data V2 including annotation data. The control portion 238 has a function of supplying the first data V11 and the second data V12.

Thus, with use of the second display element, the annotation data can be displayed so as to overlap with the image data displayed with use of the first display element. Alternatively, the annotation data can be displayed so as to overlap with the image data without an integration of the image data and the annotation data. Alternatively, the annotation data can be displayed concurrently with generation of the annotation data so as to overlap with the image data without an integration of the image data and the annotation data. Alternatively, power consumed in arithmetic operation can be reduced. Consequently, a novel display device with high convenience or high reliability can be provided.

For example, a reflective liquid crystal display element can be used as the first display element 750(i,j). Alternatively, a light-emitting element can be used as the second display element 550(i,j).

Thus, the power consumed in displaying the image data by the first display element can be reduced. Alternatively, the annotation data displayed with use of the second display element so as to overlap with the image data can be discriminated from the image data. Consequently, a novel display device with high convenience or high reliability can be provided.

### <<Image Processing Circuit 235M >>

The image processing circuit 235M includes, for example, a region 235M(1) and a region 235M(2).

The region 235M(1) has a function of storing data included in the image data V1, for example. The region 235M(2) has a function of storing data included in the image data V1 or the image data V2 including annotation data, for example.

The image processing circuit 235M has a function of correcting the image data V1 on the basis of a predetermined characteristic curve to generate the data V11 and a function of supplying the data V11. Specifically, the image processing circuit 235M has a function of generating the data V11 so that the first display element displays a favorable image. Note that a reflective liquid crystal element can be used as the first display element, for example.

The image processing circuit 235M has a function of correcting the image data V1 or the image data V2 including annotation data on the basis of a predetermined characteristic curve to generate the data V12 and a function of supplying the data V12. Specifically, the image processing circuit 235M has a function of generating the data V12 so that the second display element displays a favorable image. Note that an organic EL element can be used as the second display element.

### <Structure Example 3 of Display Device>

A display device described in this embodiment includes the display panel 700 and the control portion 238 (see FIG. 1).

### <<Control Portion 238>>

The control portion 238 has a function of receiving the image data V1, image data V2, and region data A.

The control portion 238 has a function of storing the image data V1. The control portion 238 has a function of synthesizing the image data on the basis of the image data V1, the image data V2, and the region data A. The control portion 238 has a function of supplying the first data V11 and the second data V12 on the basis of the image data.

Thus, a predetermined region can be set with use of the region data. Alternatively, a range affected by a predetermined instruction can be set with use of the region data. Alternatively, the image data V2 including a predetermined region affected by the predetermined instruction can be generated. Alternatively, the image data V1 can be stored. Alternatively, a predetermined region of the image data V2 is embedded in a predetermined region of the image data V1, so that an image data can be synthesized. Alternatively, the synthesized image data can be displayed. Consequently, a novel display device with high convenience or high reliability can be provided.

### <<Image Processing Circuit 235M >>

The image processing circuit 235M includes, for example, the region 235M(1) and the region 235M(2).

The region 235M(1) has a function of storing data included in the image data V1, for example. The region 235M(2) has a function of storing image data that is synthesized on the basis of the image data V1, the image data V2, and the region data A, for example.

In addition, the image processing circuit 235M has a function of embedding a region specified as the region data A of the image data V2 into a region specified as the region data A of the image data V1. Specifically, the image processing circuit 235M has a function of replacing data of a region specified as the region data A of image data V1 with data of a region specified as the region data A of the image data V2 to synthesize image data.

The image processing circuit 235M has a function of correcting the image data on the basis of a predetermined characteristic curve to generate the data V11 and a function of supplying the data V11. Specifically, the image processing circuit 235M has a function of generating the data V11 so that the first display element displays a favorable image. Note that a reflective liquid crystal element can be used as the first display element, for example.

The image processing circuit 235M has a function of correcting the image data on the basis of a predetermined characteristic curve to generate the data V12 and a function of supplying the data V12. Specifically, the image processing circuit 235M has a function of generating the data V12 so that the second display element displays a favorable image. Note that an organic EL element can be used as the second display element.

Note that this embodiment can be combined with any of the other embodiments in this specification as appropriate.

### Embodiment 2

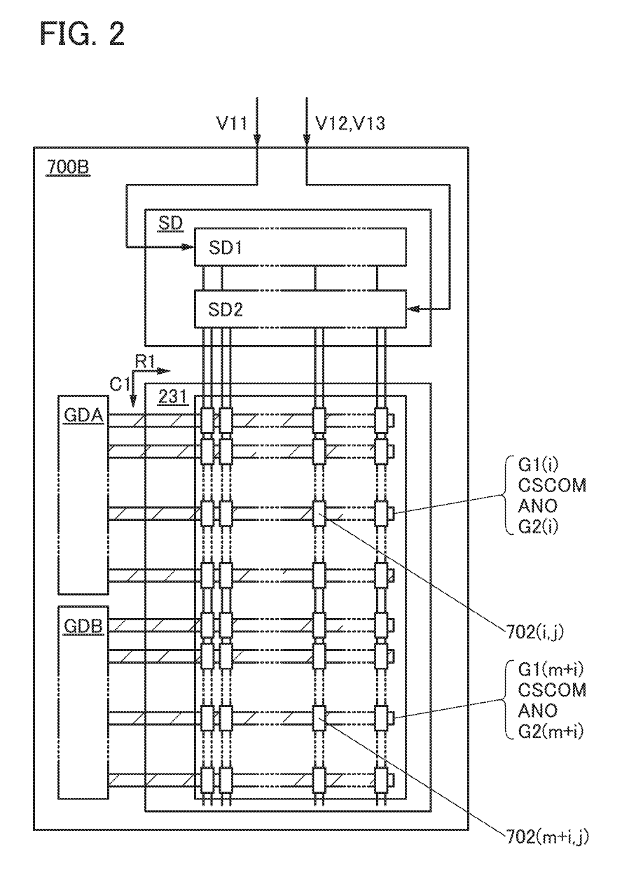

In this embodiment, a structure of the display panel 700 that can be used for the display device described in Embodiment 1 will be described with reference to FIG. 1, FIG. 2, FIGS. 3A to 3C, FIGS. 4A and 4B, FIGS. 5A and 5B, FIGS. 6A and 6B, FIG. 7, and FIGS. 8A to 8C.

FIG. 1 is a block diagram illustrating a structure of a display device of one embodiment of the present invention. The display device includes a display panel.

FIG. 2 is a block diagram illustrating a structure of a display panel of the display device of one embodiment of the present invention. FIG. 2 is a block diagram illustrating a different structure from that in FIG. 1.

FIGS. 3A to 3C illustrate a structure of a display panel that can be used for the display device of one embodiment of the present invention. FIG. 3A is a top view of the display panel, and FIG. 3B is a top view illustrating part of a pixel of the display panel in FIG. 3A. FIG. 3C is a schematic view illustrating a structure of the pixel in FIG. 3B.

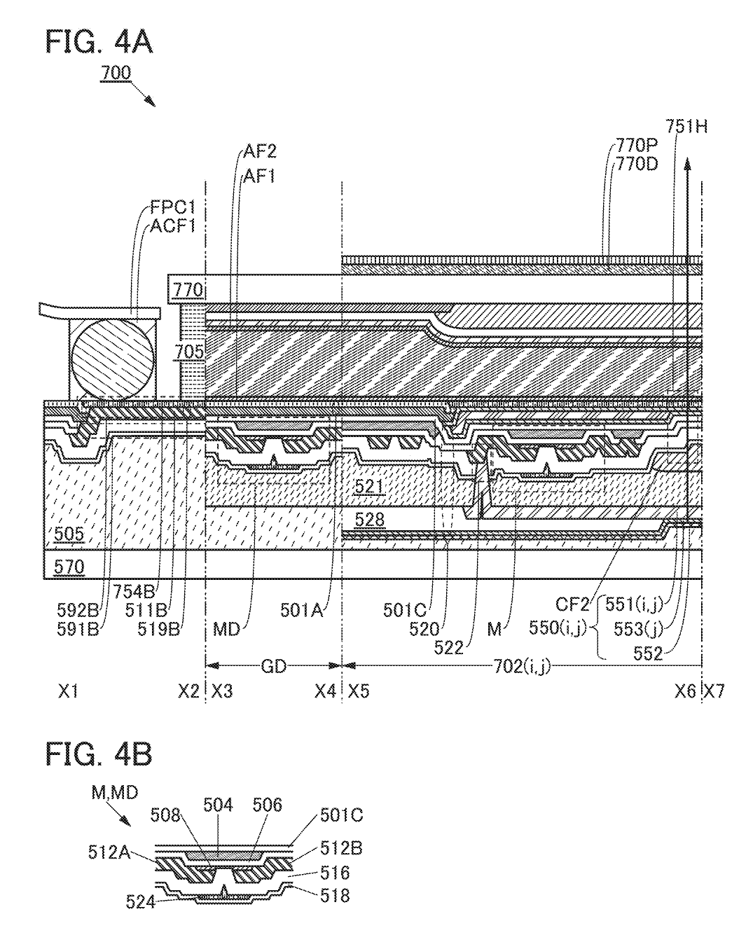

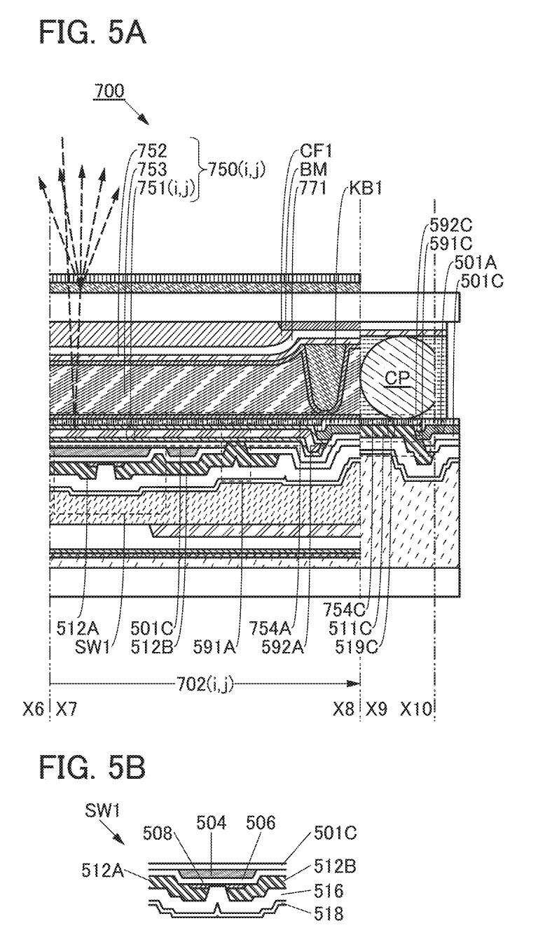

FIGS. 4A and 4B and FIGS. 5A and 5B are cross-sectional views illustrating a structure of a display panel. FIG. 4A is a cross-sectional view taken along lines X1-X2, X3-X4, and X5-X6 in FIG. 3A, and FIG. 4B illustrates part of FIG. 4A.

FIG. 5A is a cross-sectional view taken along lines X7-X8 and X9-X10 in FIG. 3A, and FIG. 5B illustrates part of FIG. 5A.

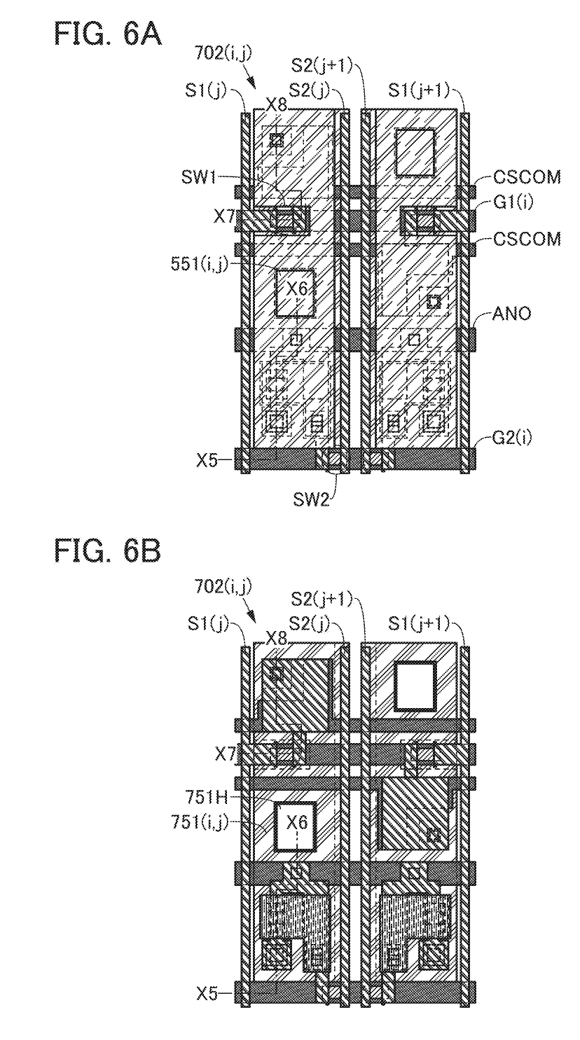

FIG. 6A is a bottom view illustrating part of the pixel of the display panel illustrated in FIG. 3B. FIG. 6B is a bottom view illustrating the part of the structure illustrated in FIG. 6A in which some components are omitted.

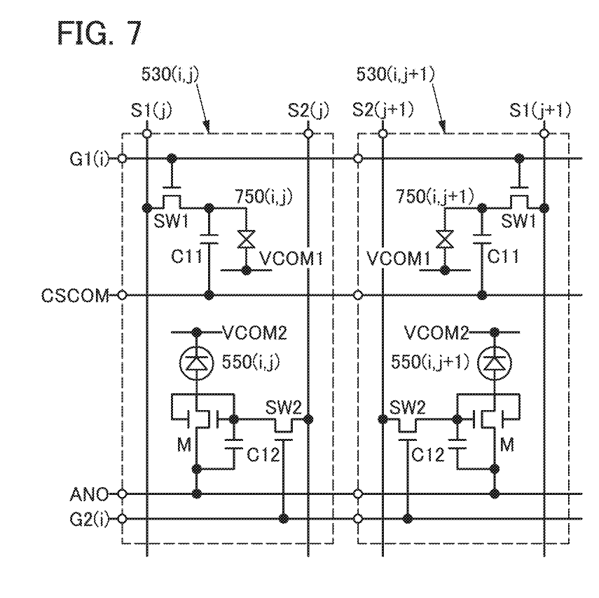

FIG. 7 is a circuit diagram illustrating a structure of a pixel circuit provided in the display panel of one embodiment of the present invention.

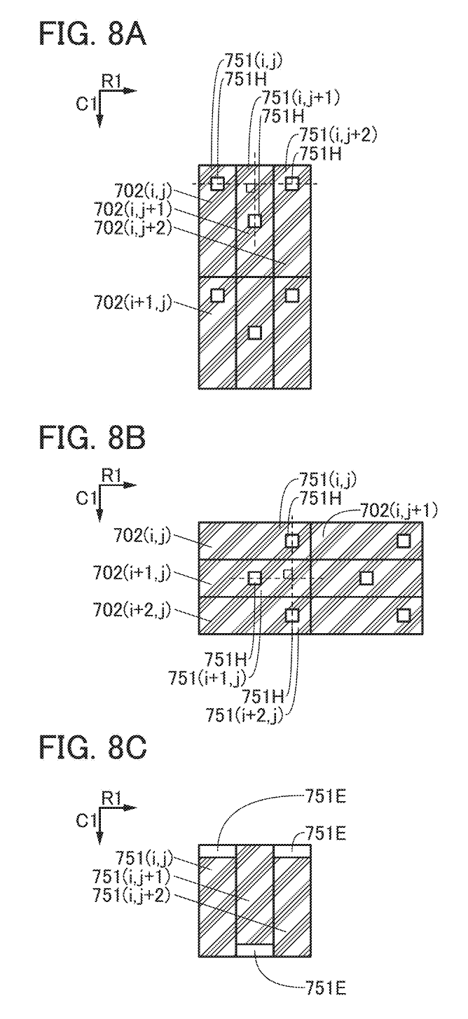

FIGS. 8A to 8C are schematic views illustrating a shape of a reflective film that can be used for a pixel of the display panel.

Note that in this specification, an integral variable of 1 or more may be used for reference numerals. For example, “(p)” where p is an integral variable of 1 or more may be used for part of a reference numeral that specifies any one of components (p components in maximum). For another example, “(m,n)” where m and n are each an integral variable of 1 or more may be used for part of a reference numeral that specifies any one of components (m×n components in maximum).

### <Structure Example of Display Panel>

The display panel 700 described in this embodiment includes a display region 231 (see FIG. 1). The display panel 700 can include a driver circuit GD and a driver circuit SD.

The display panel can include a plurality of driver circuits. For example, a display panel 700B includes a driver circuit GDA and a driver circuit GDB (see FIG. 2).

### <<Display Region 231>>

The display region 231 includes one group of pixels 702(i, 1) to 702(i,n), another group of pixels 702(1,j) to 702(m, j), and a scan line G1(i) (see FIG. 1, FIGS. 6A and 6B, or FIG. 7). In addition, a scanning line G2(i), a wiring CSCOM, a third conductive film ANO, and a signal line S2(j) are included. Note that i is an integer greater than or equal to 1 and less than or equal to m,j is an integer greater than or equal to 1 and less than or equal to n, and each of m and n is an integer greater than or equal to 1.

The one group of pixels 702(i, 1) to 702(i,n) include the pixel 702(i,j) and are provided in the row direction (the direction indicated by the arrow R1 in the drawing).

The another group of pixels 702(1,j) to 702(m,j) include the pixel 702(i,j) and are provided in the column direction (the direction indicated by the arrow C1 in the drawing) that intersects the row direction.

The scan line G1(i) and the scan line G2(i) are electrically connected to the one group of pixels 702(i, 1) to 702(i,n) provided in the row direction.

The another group of pixels 702(1,j) to 702(m,j) provided in the column direction are electrically connected to the signal line S1(j) and the signal line S2(j).

<<Driver circuit GD>>

The driver circuit GD has a function of supplying a selection signal in accordance with the control data.

For example, the driver circuit GD has a function of supplying a selection signal to one scan line at a frequency of 30 Hz or higher, preferably 60 Hz or higher, in accordance with the control data. Accordingly, moving images can be smoothly displayed.

For example, the driver circuit GD has a function of supplying a selection signal to one scan line at a frequency lower than 30 Hz, preferably lower than 1 Hz, further preferably less than once per minute, in accordance with the control data. Accordingly, a still image can be displayed while flickering is suppressed.

For example, in the case where a plurality of driver circuits is provided, the driver circuits GDA and GDB may supply the selection signals at different frequencies. Specifically, the driver circuits can supply selection signals at a higher frequency to a region where moving images are displayed smoothly than to a region where a still image is displayed while flickering is suppressed.

### <<Driver Circuit SD, Driver Circuit SD1, Driver Circuit SD2>>

The driver circuit SD includes a driver circuit SD1 and a driver circuit SD2. The driver circuit SD1 has a function of supplying an image signal on the basis of the data V11. The driver circuit SD2 has a function of supplying an image signal on the basis of the data V12 (see FIG. 1).

The driver circuit SD1 has a function of generating an image signal that is to be supplied to a pixel circuit electrically connected to one display element. Specifically, the driver circuit SD1 has a function of generating a signal whose polarity is inverted. Thus, for example, a liquid crystal display element can be driven.

The driver circuit SD2 has a function of generating an image signal that is supplied to a pixel circuit electrically connected to another display element which displays an image with a method different from that of the above display element. For example, an organic EL element can be driven.

For example, a variety of sequential circuits, such as a shift register, can be used as the driver circuit SD.

For example, an integrated circuit in which the driver circuit SD1 and the driver circuit SD2 are integrated can be used for the driver circuit SD. Specifically, an integrated circuit formed on a silicon substrate can be used as the driver circuit SD.

For example, an integrated circuit can be mounted on a terminal by a chip on glass (COG) method or a chip on film (COF) method. Specifically, an anisotropic conductive film can be used to mount an integrated circuit on the terminal.

### <Structure Example of Pixel>

The pixel 702(i,j) includes the first display element 750(i,j), the second display element 550(i,j), and part of a functional layer 520 (see FIG. 3C, FIG. 4A, and FIG. 5A).

### <<Functional Layer>>

The functional layer 520 includes a first conductive film, a second conductive film, an insulating film 501C, and a pixel circuit 530(i,j) (see FIGS. 4A and 4B). The functional layer 520 includes an insulating film 521, an insulating film 528, an insulating film 518, and an insulating film 516.

The functional layer 520 includes a region sandwiched between a substrate 570 and a substrate 770.

### <<Insulating Film 501C>>

The insulating film 501C includes a region sandwiched between the first conductive film and the second conductive film, and also have an opening 591A (see FIG. 5A).

### <<First Conductive Film>>

For example, a first electrode 751(i,j) of the first display element 750(i,j) can be used as the first conductive film. The first conductive film is electrically connected to the first electrode 751(i,j).

### <<Second Conductive Film>>

For example, a conductive film 512B can be used as the second conductive film. The second conductive film has a region overlapping with the first conductive film. The second conductive film is electrically connected to the first conductive film through the opening 591A. The first conductive film electrically connected to the second conductive film through the opening 591A provided in the insulating film 501C can be referred to as a through electrode.

The second conductive film is electrically connected to the pixel circuit 530(i,j). For example, a conductive film which functions as a source electrode or a drain electrode of a transistor used as a switch SW1 of the pixel circuit 530(i,j) can be used as the second conductive film.

### <<Pixel Circuit>>

The pixel circuit 530(i,j) has a function of driving the first display element 750(i,j) and the second display element 550(i,j) (see FIG. 7).

Accordingly, the first display element and the second display element which perform display using different methods can be driven in one pixel circuit, for example. Specifically, a reflective display element is used as the first display element, whereby the power consumption can be reduced. Alternatively, an image with high contrast can be favorably displayed in an environment with bright external light. Alternatively, the second display element which emits light is used, whereby an image can be favorably displayed in a dark environment. Alternatively, using the insulating film, impurity diffusion between the first display element and the second display element or between the first display element and the pixel circuit can be suppressed. Consequently, a novel display device with high convenience or high reliability can be provided.

A switch, a transistor, a diode, a resistor, an inductor, a capacitor, or the like can be used in the pixel circuit 530(i,j).

For example, one or a plurality of transistors can be used as a switch. Alternatively, a plurality of transistors connected in parallel, in series, or in combination of parallel connection and series connection can be used as a switch.

For example, the pixel circuit 530(i,j) is electrically connected to the signal line S1(j), the signal line S2(j), the scan line G1(i), the scan line G2(i), the wiring CSCOM, and the first conductive film ANO (see FIG. 7). Note that a conductive film 512A is electrically connected to the signal line S1(j) (see FIG. 5A and FIG. 7).

The pixel circuit 530(i,j) includes the switch SW1 and a capacitor C11 (see FIG. 7).

The pixel circuit 530(i,j) includes a switch SW2, a transistor M, and a capacitor C12.

For example, a transistor including a gate electrode electrically connected to the scan line G1(i) and a first electrode electrically connected to the signal line S1(j) can be used as the switch SW1.

The capacitor C11 includes a first electrode electrically connected to a second electrode of the transistor used as the switch SW1 and a second electrode electrically connected to the wiring CSCOM.

For example, a transistor that includes a gate electrode electrically connected to the scan line G2(i) and a first electrode electrically connected to the signal line S2(j) can be used as the switch SW2.

The transistor M includes a gate electrode electrically connected to a second electrode of the transistor used as the switch SW2 and includes a first electrode electrically connected to the third conductive film ANO.

Note that a transistor that includes a semiconductor film provided between a gate electrode and a conductive film can be used as the transistor M. For example, as the conductive film, a conductive film electrically connected to a wiring that can supply the same potential as that of the gate electrode of the transistor M can be used.

The capacitor C12 includes a first electrode electrically connected to the second electrode of the transistor used as the switch SW2 and a second electrode electrically connected to the first electrode of the transistor M.

Note that a first electrode of the first display element 750(i,j) is electrically connected to the second electrode of the transistor used as the switch SW1. A second electrode of the first display element 750(i,j) is electrically connected to a wiring VCOM1. This enables the first display element 750(i,j) to be driven.

Furthermore, a third electrode 551(i,j) and a fourth electrode 552 of the second display element 550(i,j) are electrically connected to a second electrode of the transistor M and a fourth conductive film VCOM2, respectively. This enables the second display element 550(i,j) to be driven.

<<First Display Element 750(i,j)>>

For example, a display element having a function of controlling transmission or reflection of light can be used as the first display element 750(i,j). Specifically, a reflective liquid crystal display element can be used as the first display element 750(i,j). Alternatively, a MEMS shutter display element or the like can be used. The use of a reflective display element can reduce the power consumption of a display panel.

The first display element 750(i,j) includes a first electrode 751(i,j), a second electrode 752, and a layer 753 containing a liquid crystal material. The second electrode 752 is positioned such that an electric field which controls the alignment of the liquid crystal material is generated between the second electrode 752 and the first electrode 751(i,j) (see FIG. 4A and FIG. 5A).

Note that the first display element 750(i,j) includes an alignment film AF1 and an alignment film AF2. The alignment film AF2 has such a region that the layer 753 containing a liquid crystal material is interposed between the alignment film AF1 and the alignment film AF2.

<<Second Display Element 550(i,j)>>

A display element having a function of emitting light can be used as the second display element 550(i,j), for example. Specifically, an organic EL element or the like can be used.

The second display element 550(i,j) has a function of emitting light toward the insulating film 501C (see FIG. 4A).

The second display element 550(i,j) is provided so that the display using the second display element 550(i,j) can be seen from part of a region from which the display using the first display element 750(i,j) can be seen. For example, dashed arrows shown in FIG. 5A denote the directions in which external light is incident on and reflected by the first display element 750(i,j) that displays the image data with control of the intensity of external light reflection. In addition, a solid arrow shown in FIG. 4A denotes the direction in which the second display element 550(i,j) emits light to the part of the region from which the display using the first display element 750(i,j) can be seen.

Thus, the display using the second display element can be seen from part of the region from which the display using the first display element can be seen. Alternatively, a user can view the display without changing the attitude or the like of the display panel. As a result, a novel display panel with high convenience or high reliability can be provided.

The second display element 550(i,j) includes the third electrode 551(i,j), the fourth electrode 552, a layer 553(j) containing a light-emitting material (see FIG. 4A).

The fourth electrode 552 includes a region overlapping with the third electrode 551(i,j).

The layer 553(j) containing a light-emitting material includes a region sandwiched between the third electrode 551(i,j) and the fourth electrode 552.

The third electrode 551(i,j) is electrically connected to the pixel circuit 530(i,j) at a connection portion 522. Note that the third electrode 551(i,j) and the fourth electrode 552 are electrically connected to the third conductive film ANO and the fourth conductive film VCOM2, respectively (see FIG. 7).

### <<Intermediate Film>>

The display panel described in this embodiment includes an intermediate film 754A, an intermediate film 754B, and an intermediate film 754C.

The intermediate film 754A includes a region which overlaps with the insulating film 501C with the first conductive film interposed therebetween, and the intermediate film 754A includes a region in contact with first electrode 751(i,j). The intermediate film 754B includes a region in contact with a conductive film 511B. The intermediate film 754C includes a region in contact with a conductive film 511C.

### <<Insulating Film 501A>>

The display panel described in this embodiment includes a first insulating film 501A (see FIG. 4A and FIG. 5A).

The first insulating film 501A has a first opening 592A, a second opening 592B, and an opening 592C (see FIG. 4A or FIG. 5A).

The first opening 592A includes a region overlapping with the intermediate film 754A and the first electrode 751(i,j) or a region overlapping with the intermediate film 754A and the insulating film 501C.

The second opening 592B includes a region overlapping with the intermediate film 754B and the conductive film 511B.

Furthermore, the opening 592C includes a region overlapping with the intermediate film 754C and the conductive film 511C.

The insulating film 501A includes a region where the insulating film 501C is sandwiched between the insulating film 501A and the conductive film 511B. The insulating film 501A is in contact with the conductive film 511B in an opening 591B provided in the insulating film 501C. The insulating film 501A is in contact with the conductive film 511C in an opening 591C provided in the insulating film 501C.

The insulating film 501A includes a region sandwiched between the intermediate film 754A and the insulating film 501C along the periphery of the first opening 592A. The insulating film 501A includes a region sandwiched between the intermediate film 754B and the conductive film 511B along the periphery of the second opening 592B.

### <<Insulating Film 521, Insulating Film 528, Insulating Film 518, Insulating Film 516, or the Like>>

The insulating film 521 includes a region sandwiched between the pixel circuit 530(i,j) and the second display element 550(i,j).

The insulating film 528 is provided between the insulating film 521 and the substrate 570 and has an opening in a region overlapping with the second display element 550(i,j).

The insulating film 528 formed along the periphery of the third electrode 551(i,j) can prevent a short circuit between the third electrode 551(in and the fourth electrode.

The insulating film 518 includes a region sandwiched between the insulating film 521 and the pixel circuit 530(i,j).

The insulating film 516 includes a region sandwiched between the insulating film 518 and the pixel circuit 530(i,j).

### <<Terminal or the Like>>

The display panel described in this embodiment includes a terminal 519B and a terminal 519C.

The terminal 519B includes the conductive film 511B and the intermediate film 754B, and the intermediate film 754B includes a region in contact with the conductive film 511B. The terminal 519B is electrically connected to the signal line S1(j), for example.

The terminal 519C includes the conductive film 511C and the intermediate film 754C, and the intermediate film 754C includes a region in contact with the conductive film 511C. The conductive film 511C is electrically connected to the wiring VCOM1, for example.

A conductive material CP is sandwiched between the terminal 519C and the second electrode 752, and has a function of electrically connecting the terminal 519C and the second electrode 752. For example, a conductive particle can be used as the conductive material CP.

### <<Substrate or the Like>>

The display panel described in this embodiment includes the substrate 570 and the substrate 770.

The substrate 770 includes a region overlapping with the substrate 570. The substrate 770 includes a region where the functional layer 520 is interposed between the substrate 770 and the substrate 570.

### <<Bonding Layer, Sealing Material, Structure Body, or the Like>>

The display panel described in this embodiment also includes a bonding layer 505, a sealant 705, and a structure body KB1.

The bonding layer 505 includes a region sandwiched between the functional layer 520 and the substrate 570, and has a function of bonding the functional layer 520 and the substrate 570 together.

The sealant 705 includes a region sandwiched between the functional layer 520 and the substrate 770, and has a function of bonding the functional layer 520 and the substrate 770 together.

The structure body KB1 has a function of providing a certain space between the functional layer 520 and the substrate 770.

### <<Functional Film or the Like>>

The display panel described in this embodiment includes a light-blocking film BM, an insulating film 771, a functional film 770P, and a functional film 770D. In addition, a coloring film CF1 and a coloring film CF2 are included.

The light-blocking film BM has an opening in a region overlapping with the first display element 750(i,j). The coloring film CF2 is provided between the insulating film 501C and the second display element 550(i,j) and includes a region overlapping with an opening 751H (see FIG. 4A).

The insulating film 771 includes a region sandwiched between the coloring film CF1 and the layer 753 containing a liquid crystal material or between the light-blocking film BM and the layer 753 containing a liquid crystal material. Thus, unevenness due to the thickness of the coloring film CF1 can be avoided. Alternatively, impurities can be prevented from being diffused from the light-blocking film BM, the coloring film CF1, or the like to the layer 753 containing a liquid crystal material

A functional film 770P includes a region overlapping with the first display element 750(i,j).

The functional film 770D includes a region overlapping with the first display element 750(i,j). The functional film 770D is provided so that a substrate 770 lies between the functional film 770D and the first display element 750(i, j). This can diffuse light reflected by the first display element 750(i,j), for example.

### <Example of Component>

The display panel 700 includes the substrate 570, the substrate 770, the structure body KB1, the sealant 705, or the bonding layer 505.

In addition, the display panel 700 includes the functional layer 520, the insulating film 521, or the insulating film 528.

The display panel 700 also includes the signal line S1(j), the signal line S2(j), the scan line G1(i), the scan line G2(i), the wiring CSCOM, or the third conductive film ANO.

In addition, the display panel 700 includes the first conductive film or the second conductive film.

The display panel 700 also includes the terminal 519B, the terminal 519C, the conductive film 511B, or the conductive film 511C.

The display panel 700 also includes the pixel circuit 530(i,j) or the switch SW1.

The display panel 700 also includes the first display element 750(i,j), the first electrode 751(i,j), the reflective film, the opening, the layer 753 containing a liquid crystal material, or the second electrode 752.

In addition, the display panel 700 includes the alignment film AF1, the alignment film AF2, the coloring film CF1, the coloring film CF2, the light-blocking film BM, the insulating film 771, the functional film 770P, or the functional film 770D.

In addition, the display panel 700 includes the second display element 550(i,j), the third electrode 551(i,j), the fourth electrode 552, or the layer 553(j) containing a light-emitting material.

In addition, the display panel 700 includes the insulating film 501A and the insulating film 501C.

In addition, the display panel 700 includes the driver circuit GD or the driver circuit SD.

### <<Substrate 570>>

The substrate 570 or the like can be formed using a material having heat resistance high enough to withstand heat treatment in the manufacturing process. For example, a material with a thickness less than or equal to 0.7 mm and greater than or equal to 0.1 mm can be used as the substrate 570. Specifically, a material polished to a thickness of approximately 0.1 mm can be used.

For example, a large-sized glass substrate having any of the following sizes can be used as the substrate 570 or the like: the 6th generation (1500 mm×1850 mm), the 7th generation (1870 mm×2200 mm), the 8th generation (2200 mm×2400 mm), the 9th generation (2400 mm×2800 mm), and the 10th generation (2950 mm×3400 mm). Thus, a large-sized display device can be manufactured.

For the substrate 570 or the like, an organic material, an inorganic material, a composite material of an organic material and an inorganic material, or the like can be used. For example, an inorganic material such as glass, ceramic, or metal can be used for the substrate 570 or the like.

Specifically, non-alkali glass, soda-lime glass, potash glass, crystal glass, aluminosilicate glass, tempered glass, chemically tempered glass, quartz, sapphire, or the like can be used for the substrate 570 or the like. Specifically, an inorganic oxide film, an inorganic nitride film, an inorganic oxynitride film, or the like can be used for the substrate 570 or the like. For example, a silicon oxide film, a silicon nitride film, a silicon oxynitride film, an aluminum oxide film, or the like can be used for the substrate 570 or the like. Stainless steel, aluminum, or the like can be used for the substrate 570 or the like.

For example, a single crystal semiconductor substrate or a polycrystalline semiconductor substrate of silicon or silicon carbide, a compound semiconductor substrate of silicon germanium or the like, an SOI substrate, or the like can be used as the substrate 570 or the like. Thus, a semiconductor element can be provided over the substrate 570 or the like.

For example, an organic material such as a resin, a resin film, or plastic can be used for the substrate 570 or the like. Specifically, a resin film or a resin plate of polyester, polyolefin, polyamide, polyimide, polycarbonate, an acrylic resin, or the like can be used for the substrate 570 or the like.

For example, a composite material formed by attaching a metal plate, a thin glass plate, or a film of an inorganic material to a resin film or the like can be used for the substrate 570 or the like. For example, a composite material formed by dispersing a fibrous or particulate metal, glass, an inorganic material, or the like into a resin film can be used for the substrate 570 or the like. For example, a composite material formed by dispersing a fibrous or particulate resin, an organic material, or the like into an inorganic material can be used for the substrate 570 or the like.

Furthermore, a single-layer material or a layered material in which a plurality of layers are stacked can be used for the substrate 570 or the like. For example, a layered material in which a base, an insulating film that prevents diffusion of impurities contained in the base, and the like are stacked can be used for the substrate 570 or the like. Specifically, a layered material in which glass and one or a plurality of films that are selected from a silicon oxide layer, a silicon nitride layer, a silicon oxynitride layer, and the like and that prevent diffusion of impurities contained in the glass are stacked can be used for the substrate 570 or the like. Alternatively, a layered material in which a resin and a film for preventing diffusion of impurities that penetrate the resin, such as a silicon oxide film, a silicon nitride film, or a silicon oxynitride film, are stacked can be used for the substrate 570 or the like.

Specifically, a resin film, a resin plate, a layered material, or the like of polyester, polyolefin, polyamide, polyimide, polycarbonate, an acrylic resin, or the like can be used for the substrate 570 or the like.

Specifically, a material including polyester, polyolefin, polyamide (e.g., nylon or aramid), polyimide, polycarbonate, polyurethane, an acrylic resin, an epoxy resin, or a resin having a siloxane bond, such as silicone, can be used for the substrate 570 or the like.

Specifically, polyethylene terephthalate (PET), polyethylene naphthalate (PEN), polyethersulfone (PES), an acrylic resin, or the like can be used for the substrate 570 or the like. Alternatively, a cyclo olefin polymer (COP), a cyclo olefin copolymer (COC), or the like can be used.

Alternatively, paper, wood, or the like can be used for the substrate 570 or the like.

For example, a flexible substrate can be used as the substrate 570 or the like.

Note that a transistor, a capacitor, or the like can be directly formed on the substrate. Alternatively, a transistor, a capacitor, or the like is formed over a substrate which can withstand heat applied in the manufacturing process, and then the transistor, the capacitor, or the like can be transferred to the substrate 570 or the like. Accordingly, a transistor, a capacitor, or the like can be formed over a flexible substrate, for example.

### <<Substrate 770>>

For example, a light-transmitting material can be used for the substrate 770. Specifically, any of the materials that can be used for the substrate 570 can be used for the substrate 770.

For example, aluminosilicate glass, tempered glass, chemically tempered glass, sapphire, or the like can be favorably used for the substrate 770 that is provided on the user side of the display panel. This can prevent damage or a crack of the display panel caused by the use thereof.

Moreover, a material having a thickness greater than or equal to 0.1 mm and less than or equal to 0.7 mm, for example, can be used for the substrate 770. Specifically, a substrate polished for reducing the thickness can be used. Thus, the functional film 770D can be located so as to be close to the first display element 750(i,j). As a result, image blur can be reduced and an image can be displayed clearly.

### <<Structure Body KB1>>

For example, an organic material, an inorganic material, or a composite material of an organic material and an inorganic material can be used for the structure body KB1 or the like. Accordingly, a predetermined space can be provided between components between which the structure KB1 and the like are provided.

Specifically, for the structure body KB1, polyester, polyolefin, polyamide, polyimide, polycarbonate, polysiloxane, an acrylic resin, or the like, or a composite material of a plurality of resins selected from these can be used. Alternatively, a photosensitive material may be used.

### <<Sealant 705>>

For the sealant 705 or the like, an inorganic material, an organic material, a composite material of an inorganic material and an organic material, or the like can be used.

For example, an organic material such as a thermally fusible resin or a curable resin can be used for the sealant 705 or the like.

For example, an organic material such as a reactive curable adhesive, a light curable adhesive, a thermosetting adhesive, and/or an anaerobic adhesive can be used for the sealant 705 or the like.

Specifically, an adhesive containing an epoxy resin, an acrylic resin, a silicone resin, a phenol resin, a polyimide resin, an imide resin, a polyvinyl chloride (PVC) resin, a polyvinyl butyral (PVB) resin, an ethylene vinyl acetate (EVA) resin, or the like can be used for the sealant 705 or the like.

### <<Bonding Layer 505>>

For example, any of the materials that can be used for the sealant 705 can be used for the bonding layer 505.

### <<Insulating Film 521>>

For example, an insulating inorganic material, an insulating organic material, or an insulating composite material containing an inorganic material and an organic material can be used for the insulating film 521 or the like.

Specifically, an inorganic oxide film, an inorganic nitride film, an inorganic oxynitride film, or a layered material obtained by stacking some of these films can be used as the insulating film 521 or the like. For example, a film including any of a silicon oxide film, a silicon nitride film, a silicon oxynitride film, an aluminum oxide film, and the like, or a film including a material obtained by stacking some of these films can be used as the insulating film 521 or the like.

Specifically, for the insulating film 521 or the like, polyester, polyolefin, polyamide, polyimide, polycarbonate, polysiloxane, an acrylic resin, or the like, or a layered or composite material of a plurality of kinds of resins selected from these can be used. Alternatively, a photosensitive material may be used.

Thus, steps due to various components overlapping with the insulating film 521, for example, can be reduced.

### <<Insulating Film 528>>

For example, any of the materials that can be used for the insulating film 521 can be used for the insulating film 528 or the like. Specifically, a 1-μm-thick polyimide-containing film can be used as the insulating film 528.

### <<Insulating Film 501A>>

For example, any of the materials that can be used for the insulating film 521 can be used for the insulating film 501A. For example, a material having a function of supplying hydrogen can be used for the insulating film 501A.

Specifically, a material obtained by stacking a material containing silicon and oxygen and a material containing silicon and nitrogen can be used for the insulating film 501A. For example, a material having a function of releasing hydrogen by heating or the like to supply the hydrogen to another component can be used for the insulating film 501A. Specifically, a material having a function of releasing hydrogen taken in the manufacturing process, by heating or the like, to supply the hydrogen to another component can be used for the insulating film 501A.

For example, a film containing silicon and oxygen that is formed by a chemical vapor deposition method using silane or the like as a source gas can be used as the insulating film 501A.

Specifically, a material obtained by stacking a material containing silicon and oxygen and having a thickness greater than or equal to 200 nm and less than or equal to 600 nm and a material containing silicon and nitrogen and having a thickness of approximately 200 nm can be used for the insulating film 501A.

### <<Insulating Film 501C>>

For example, any of the materials that can be used for the insulating film 521 can be used for the insulating film 501C. Specifically, a material containing silicon and oxygen can be used for the insulating film 501C. Thus, impurity diffusion into the pixel circuit or the second display element can be suppressed.

For example, a 200-nm-thick film containing silicon, oxygen, and nitrogen can be used as the insulating film 501C.

### <<Intermediate Film 754A, Intermediate Film 754B, and Intermediate Film 754C>>

For example, a film with a thickness greater than or equal to 10 nm and less than or equal to 500 nm, preferably greater than or equal to 10 nm and less than or equal to 100 nm can be used as the intermediate film 754A, the intermediate film 754B, or the intermediate film 754C. In this specification, the intermediate film 754A, the intermediate film 754B, or the intermediate film 754C is referred to as an intermediate film.

For example, a material having a function of allowing the passage of hydrogen or the supply of hydrogen can be used for the intermediate film.

For example, a conductive material can be used for the intermediate film.

For example, a light-transmitting material can be used for the intermediate film.

Specifically, a material containing indium and oxygen, a material containing indium, gallium, zinc, and oxygen, a material containing indium, tin, and oxygen, or the like can be used for the intermediate film. Note that these materials have a function of allowing the passage of hydrogen.

Specifically, a 50- or 100-nm-thick film containing indium, gallium, zinc, and oxygen can be used as the intermediate film.

Note that a material obtained by stacking films serving as an etching stopper can be used as the intermediate film. Specifically, a layered material obtained by stacking a 50-nm-thick film containing indium, gallium, zinc, and oxygen and a 20-nm-thick film containing indium, tin, and oxygen, in this order, can be used for the intermediate film.

### <<Wiring, Terminal, Conductive Film>>

A conductive material can be used for a wiring or the like. Specifically, the conductive material can be used for the signal line S1(j), the signal line S2(j), the scan line G1(i), the scan line G2(i), the wiring CSCOM, the third conductive film ANO, the terminal 519B, the terminal 519C, the conductive film 511B, the conductive film 511C, or the like.

For example, an inorganic conductive material, an organic conductive material, a metal material, a conductive ceramic material, or the like can be used for the wiring or the like.

Specifically, a metal element selected from aluminum, gold, platinum, silver, copper, chromium, tantalum, titanium, molybdenum, tungsten, nickel, iron, cobalt, palladium, and manganese, or the like can be used for the wiring or the like. Alternatively, an alloy including any of the above-described metal elements, or the like can be used for the wiring or the like. In particular, an alloy of copper and manganese is suitably used in microfabrication with use of a wet etching method.

Specifically, a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure in which a titanium film, an aluminum film, and a titanium film are stacked in this order, or the like can be used for the wiring or the like.

Specifically, a conductive oxide such as indium oxide, indium tin oxide, indium zinc oxide, zinc oxide, or zinc oxide to which gallium is added can be used for the wiring or the like.

Specifically, a film containing graphene or graphite can be used for the wiring or the like.

For example, a film including graphene oxide is formed and is reduced, so that a film including graphene can be formed. As a reducing method, a method using heat, a method using a reducing agent, or the like can be employed.

For example, a film including a metal nanowire can be used for the wiring or the like. Specifically, a nanowire including silver can be used.

Specifically, a conductive polymer molecule can be used for the wiring or the like.

Note that the terminal 519B can be electrically connected to a flexible printed circuit FPC1 using a conductive material ACF1, for example.

### <<First Conductive Film, Second Conductive Film>>

For example, the material that can be used for the wiring or the like can be used for the first conductive film or the second conductive film.

Alternatively, the first electrode 751(i,j), the wiring, or the like can be used for the first conductive film.

For example, the conductive film 512B serving as a source electrode or a drain electrode of a transistor that can be used as the switch SW1, or the wiring or the like can be used for the second conductive film.

<<First Display Element 750(i,j)>>

For example, a display element having a function of controlling transmission or reflection of light can be used as the first display element 750(i,j). For example, a combined structure of a liquid crystal element and a polarizing plate or a MEMS shutter display element can be used. Specifically, a reflective liquid crystal display element can be used as the first display element 750(i,j). The use of a reflective display element can reduce the power consumption of a display panel.

For example, a liquid crystal element that can be driven by any of the following driving methods can be used: an in-plane switching (IPS) mode, a twisted nematic (TN) mode, a fringe field switching (FFS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, and the like.

In addition, a liquid crystal element that can be driven by, for example, a vertical alignment (VA) mode such as a multi-domain vertical alignment (MVA) mode, a patterned vertical alignment (PVA) mode, an electrically controlled birefringence (ECB) mode, a continuous pinwheel alignment (CPA) mode, or an advanced super view (ASV) mode can be used.

The first display element 750(i,j) includes the first electrode, the second electrode, and a layer containing a liquid crystal material. The layer containing a liquid crystal material contains a liquid crystal material whose orientation is controlled by a voltage applied between the first electrode and the second electrode. For example, the orientation of the liquid crystal material can be controlled by an electric field in the thickness direction (also referred to as the vertical direction) or the direction that crosses the vertical direction (the horizontal direction, or the diagonal direction) of the layer containing a liquid crystal material.

### <<Layer 753 Containing Liquid Crystal Material>>

For example, thermotropic liquid crystal, low-molecular liquid crystal, high-molecular liquid crystal, polymer dispersed liquid crystal, ferroelectric liquid crystal, anti-ferroelectric liquid crystal, or the like can be used for the layer 753 containing a liquid crystal material. A liquid crystal material that exhibits a cholesteric phase, a smectic phase, a cubic phase, a chiral nematic phase, an isotropic phase, or the like can be used. Alternatively, a liquid crystal material that exhibits a blue phase can be used.

<<First Electrode 751(i,j)>>

For example, the material that is used for the wiring or the like can be used for the first electrode 751(i,j). Specifically, a reflective film can be used for the first electrode 751(i,j). For example, a material in which a light-transmitting conductive film and a reflective film having an opening are stacked can be used for the first electrode 751(i,j).

### <<Reflective Film>>

For example, a material reflecting visible light can be used for the reflective film. Specifically, a material containing silver can be used for the reflective film. For example, a material containing silver, palladium, and the like or a material containing silver, copper, and the like can be used for the reflective film.

The reflective film reflects light that passes through the layer 753 containing a liquid crystal material, for example. This allows the first display element 750(i,j) to serve as a reflective liquid crystal element. Alternatively, a material with an uneven surface can be used for the reflective film. In that case, incident light can be reflected in various directions so that a white image can be displayed.

For example, the first conductive film, the first electrode 751(i,j), or the like can be used as the reflective film.

For example, the reflective film can be provided as a film including a region sandwiched between the layer 753 containing a liquid crystal material and the first electrode 751(i,j). Alternatively, the reflective film can be used as a film including a region provided so that the first electrode 751(i,j) is positioned between the region and the layer 753 containing a liquid crystal material.

The reflective film has a shape, for example, including a region that does not block light emitted from the second display element 550(i,j).

For example, the reflective film may have a shape with one or a plurality of openings.

The opening may have a polygonal shape, a quadrangular shape, an elliptical shape, a circular shape, a cross-like shape, or the like. The opening 751H may also have a stripe shape, a slit-like shape, or a checkered pattern.

If the ratio of the total area of the opening 751H to the total area except for the openings is too high, display performed using the first display element 750(i,j) is dark.

If the ratio of the total area of the opening 751H to the total area except for the openings is too low, display performed using the second display element 550(i,j) is dark. Alternatively, the reliability of the second display element 550(i,j) is reduced in some cases.

The opening 751H of the pixel 702(i,j+1), which is adjacent to the pixel 702(i,j), is not provided on a line that extends in the row direction (the direction indicated by the arrow R1 in each of FIGS. 8A to 8C) through the opening 751H of the pixel 702(i,j) (see FIG. 8A). Alternatively, for example, the opening 751H of the pixel 702(i+1,j), which is adjacent to the pixel 702(i,j), is not provided on a line that extends in the column direction (the direction indicated by the arrow C1 in each of FIGS. 8A to 8C) through the opening 751H of the pixel 702(i,j) (see FIG. 8B).

For example, the opening 751H of the pixel 702(i,j+2) is provided on a line that extends in the row direction through the opening 751H of the pixel 702(i,j) (see FIG. 8A). In addition, the opening 751H of the pixel 702(i,j+1) is provided on a line that is perpendicular to the above-mentioned line between the opening 751H of the pixel 702(i,j) and the opening 751H of the pixel 702(i,j+2).

Alternatively, for example, the opening 751H of the pixel 702(i+2,j) is provided on a line that extends in the column direction through the opening 751H of the pixel 702(i,j) (see FIG. 8B). In addition, for example, the opening 751H of the pixel 702(i+1,j) is provided on a line that is perpendicular to the above-mentioned line between the opening 751H of the pixel 702(i,j) and the opening 751H of the pixel 702(i+2,j).

Thus, a second display element that includes a region overlapping with an opening of a pixel adjacent to one pixel can be apart from a second display element that includes a region overlapping with an opening of the one pixel. Furthermore, a display element that exhibits color different from that exhibited by the second display element of the one pixel can be provided as the second display element of the pixel adjacent to the one pixel. Furthermore, the difficulty in adjacently arranging a plurality of display elements that exhibit different colors can be lowered. As a result, a novel display panel with high convenience or high reliability can be provided.

For example, the reflective film can be formed using a material having a shape in which an end portion is cut off so as to form a region 751E that does not block light emitted from the second display element 550(i,j) (see FIG. 8C). Specifically, the first electrode 751(i,j) whose end portion is cut off so as to be shorter in the column direction (the direction indicated by the arrow C1 in the drawing) can be used as the reflective film.

### <<Second Electrode 752>>

For example, a material having conductivity can be used for the second electrode 752. For example, a material having a visible-light-transmitting property can be used for the second electrode 752.

For example, a conductive oxide, a metal film thin enough to transmit light, or a metal nanowire can be used for the second electrode 752.

Specifically, a conductive oxide containing indium can be used for the second electrode 752. Alternatively, a metal thin film with a thickness greater than or equal to 1 nm and less than or equal to 10 nm can be used for the second electrode 752. Alternatively, a metal nanowire containing silver can be used for the second electrode 752.

Specifically, indium oxide, indium tin oxide, indium zinc oxide, zinc oxide, zinc oxide to which gallium is added, zinc oxide to which aluminum is added, or the like can be used for the second electrode 752.

### <<Alignment Film AF1 and Alignment Film AF2>>

For example, the alignment films AF1 and AF2 can be formed with a material containing polyimide or the like. Specifically, a material formed by rubbing treatment or an optical alignment technique so that a liquid crystal material has alignment in a predetermined direction can be used.

For example, a film containing soluble polyimide can be used as the alignment film AF1 or AF2. In this case, the temperature required in forming the alignment film AF1 or AF2 can be low. Accordingly, damage to other components at the time of forming the alignment film AF1 or AF2 can be suppressed.

### <<Coloring Film CF1 and Coloring Film CF2>>

A material transmitting light of a predetermined color can be used for the coloring film CF1 or the coloring film CF2. Thus, the coloring film CF1 or the coloring film CF2 can be used as a color filter, for example. For example, a material that transmits blue light, green light, or red light can be used for the coloring film CF1 or the coloring film CF2. Furthermore, a material that transmits yellow light, white light, or the like can be used for the coloring film CF1 or the coloring film CF2.

Note that a material having a function of converting the emitted light to a predetermined color light can be used for the coloring film CF2. Specifically, quantum dots can be used for the coloring film CF2. Thus, display with high color purity can be achieved.

### <<Light-Blocking Film BM>>

A material that prevents light transmission can be used for the light-blocking film BM. Thus, the light-blocking film BM can be used as, for example, a black matrix.

### <<Insulating Film 771>>

The insulating film 771 can be formed of polyimide, an epoxy resin, an acrylic resin, or the like, for example.

### <<Functional Film 770P and Functional Film 770D>>

For example, an anti-reflection film, a polarizing film, a retardation film, a light diffusion film, a condensing film, or the like can be used as the functional film 770P or the functional film 770D.

Specifically, a film containing a dichromatic pigment can be used as the functional film 770P or the functional film 770D. Furthermore, a material having a pillar-shaped structure with an axis in a direction that intersects a surface of the substrate can be used for the functional film 770P or the functional film 770D. This makes it easy to transmit light in a direction along the axis and to scatter light in the other directions.

Alternatively, an antistatic film preventing the attachment of a foreign substance, a water repellent film suppressing the attachment of stain, a hard coat film suppressing a scratch in use, or the like can be used as the functional film 770P.

Specifically, a circularly polarizing film can be used as the functional film 770P. Furthermore, a light diffusion film can be used as the functional film 770D.

<<Second Display Element 550(i,j)>>

For example, the second display element 550(i,j) can be a light-emitting element. Specifically, an organic electroluminescent element, an inorganic electroluminescent element, a light-emitting diode, or the like can be used as the second display element 550(i,j).

For example, a light-emitting organic compound can be used for the layer 553(j) containing a light-emitting material.

For example, quantum dots can be used for the layer 553(j) containing a light-emitting material. Accordingly, the half width becomes narrow, and light of a bright color can be emitted.

For example, a layered material for emitting blue light, green light, or red light, or the like can be used for the layer 553(j) containing a light-emitting material.

For example, a belt-like layered material that extends in the column direction along the signal line S2(j) can be used for the layer 553(j) containing a light-emitting material.

Alternatively, a layered material for emitting white light can be used for the layer 553(j) containing a light-emitting material. Specifically, a layered material in which a layer containing a light-emitting material including a fluorescent material that emits blue light, and a layer containing a material that is other than a fluorescent material and that emits green light and/or red light or a layer containing a material that is other than a fluorescent material and that emits yellow light are stacked can be used for the layer 553(j) containing a light-emitting material.

For example, a material that can be used for the wiring or the like can be used for the third electrode 551(i,j).

For example, a material that transmits visible light selected from materials that can be used for the wiring or the like can be used for the third electrode 551(i,j).

Specifically, conductive oxide, indium-containing conductive oxide, indium oxide, indium tin oxide, indium zinc oxide, zinc oxide, zinc oxide to which gallium is added, or the like can be used for the third electrode 551(i,j). Alternatively, a metal film that is thin enough to transmit light can be used as the third electrode 551(i,j). Further alternatively, a metal film that transmits part of light and reflects another part of light can be used as the third electrode 551(i,j). Thus, the second display element 550(i,j) can be provided with a microcavity structure. Consequently, light of a predetermined wavelength can be extracted more efficiently than light of the other wavelengths.

For example, a material that can be used for the wiring or the like can be used for the fourth electrode 552. Specifically, a material that reflects visible light can be used for the fourth electrode 552.

### <<Driver Circuit GD>>

Any of a variety of sequential circuits, such as a shift register, can be used as the driver circuit GD. For example, a transistor MD, a capacitor, and the like can be used in the driver circuit GD. Specifically, a transistor including a semiconductor film that can be formed in the same process as the transistor M or the transistor which can be used as the switch SW1 can be used.

As the transistor MD, a transistor having a different structure from the transistor that can be used as the switch SW1 can be used, for example. Specifically, a transistor including a conductive film 524 can be used as the transistor MD (see FIG. 4B).

Note that the transistor MD can have the same structure as the transistor M.

### <<Transistor>>

For example, semiconductor films formed at the same step can be used for transistors in the driver circuit and the pixel circuit.

For example, a bottom-gate transistor, a top-gate transistor, or the like can be used for transistors in a driver circuit or a pixel circuit.

A manufacturing line for a bottom-gate transistor including amorphous silicon as a semiconductor can be easily remodeled into a manufacturing line for a bottom-gate transistor including an oxide semiconductor as a semiconductor, for example. Furthermore, for example, a manufacturing line for a top-gate transistor including polysilicon as a semiconductor can be easily remodeled into a manufacturing line for a top-gate transistor including an oxide semiconductor as a semiconductor. In any reconstruction, a conventional manufacturing line can be effectively used.

For example, a transistor including a semiconductor containing an element belonging to Group 14 in a semiconductor film can be used. Specifically, a semiconductor containing silicon can be used for a semiconductor film. For example, single crystal silicon, polysilicon, microcrystalline silicon, amorphous silicon, or the like can be used for the semiconductor film of the transistor.

Note that the temperature for forming a transistor using polysilicon as a semiconductor is lower than the temperature for forming a transistor using single crystal silicon as a semiconductor.

In addition, the transistor using polysilicon as a semiconductor has higher field-effect mobility than the transistor using amorphous silicon as a semiconductor, and therefore a pixel including the transistor using polysilicon can have a high aperture ratio. Moreover, pixels arranged at high resolution, a gate driver circuit, and a source driver circuit can be formed over the same substrate. As a result, the number of components included in an electronic device can be reduced.

In addition, the transistor using polysilicon as a semiconductor has higher reliability than the transistor using amorphous silicon as a semiconductor.

Alternatively, for example, a transistor including a compound semiconductor can be used. Specifically, a semiconductor containing gallium arsenide can be used in a semiconductor film.

For example, a transistor including an organic semiconductor can be used. Specifically, an organic semiconductor containing any of polyacenes and graphene can be used in the semiconductor film.

For example, a transistor including an oxide semiconductor in a semiconductor film can be used. Specifically, an oxide semiconductor containing indium or an oxide semiconductor containing indium, gallium, and zinc can be used for a semiconductor film.

For example, a transistor having a lower leakage current in an off state than a transistor that uses amorphous silicon in a semiconductor film can be used. Specifically, a transistor that uses an oxide semiconductor in a semiconductor film can be used.

Thus, a pixel circuit can hold an image signal for a longer time than a pixel circuit including a transistor that uses amorphous silicon for a semiconductor film. Specifically, a selection signal can be supplied at a frequency of lower than 30 Hz, preferably lower than 1 Hz, further preferably less than once per minute while flickering is suppressed. Consequently, eyestrain on a user of a data processing device can be reduced, and power consumption for driving can be reduced.

For example, a transistor including a semiconductor film 508, a conductive film 504, the conductive film 512A, and the conductive film 512B can be used as the switch SW1 (see FIG. 5B). Note that an insulating film 506 includes a region sandwiched between the semiconductor film 508 and the conductive film 504.

The conductive film 504 includes a region overlapping with the semiconductor film 508. The conductive film 504 has a function of a gate electrode. The insulating film 506 has a function of a gate insulating film.

The conductive film 512A and the conductive film 512B are electrically connected to the semiconductor film 508. The conductive film 512A has one of a function of a source electrode and a function of a drain electrode, and the conductive film 512B has the other.

A transistor including the conductive film 524 can be used as the transistor in the driver circuit or the pixel circuit (see FIG. 4B). The conductive film 524 includes a region so that the semiconductor film 508 is sandwiched between the conductive film 504 and the region. Note that the insulating film 516 includes a region sandwiched between the conductive film 524 and the semiconductor film 508. For example, the conductive film 524 is electrically connected to a wiring that supplies the same potential as that supplied to the conductive film 504.

A conductive film in which a 10-nm-thick film containing tantalum and nitrogen and a 300-nm-thick film containing copper are stacked in this order can be used as the conductive film 504, for example. Note that the film containing copper includes a region so that the film containing tantalum and nitrogen is sandwiched between the region and the insulating film 506.

A material in which a 400-nm-thick film containing silicon and nitrogen and a 200-nm-thick film containing silicon, oxygen, and nitrogen are stacked can be used for the insulating film 506, for example. Note that the film containing silicon and nitrogen includes a region so that the film containing silicon, oxygen, and nitrogen is sandwiched between the region and the semiconductor film 508.

A 25-nm-thick film containing indium, gallium, and zinc can be used as the semiconductor film 508, for example.

A conductive film in which a 50-nm-thick film containing tungsten, a 400-nm-thick film containing aluminum, and a 100-nm-thick film containing titanium are stacked in this order can be used as the conductive film 512A or the conductive film 512B, for example. Note that the film containing tungsten includes a region in contact with the semiconductor film 508.

This embodiment can be combined with any other embodiment as appropriate.

### Embodiment 3

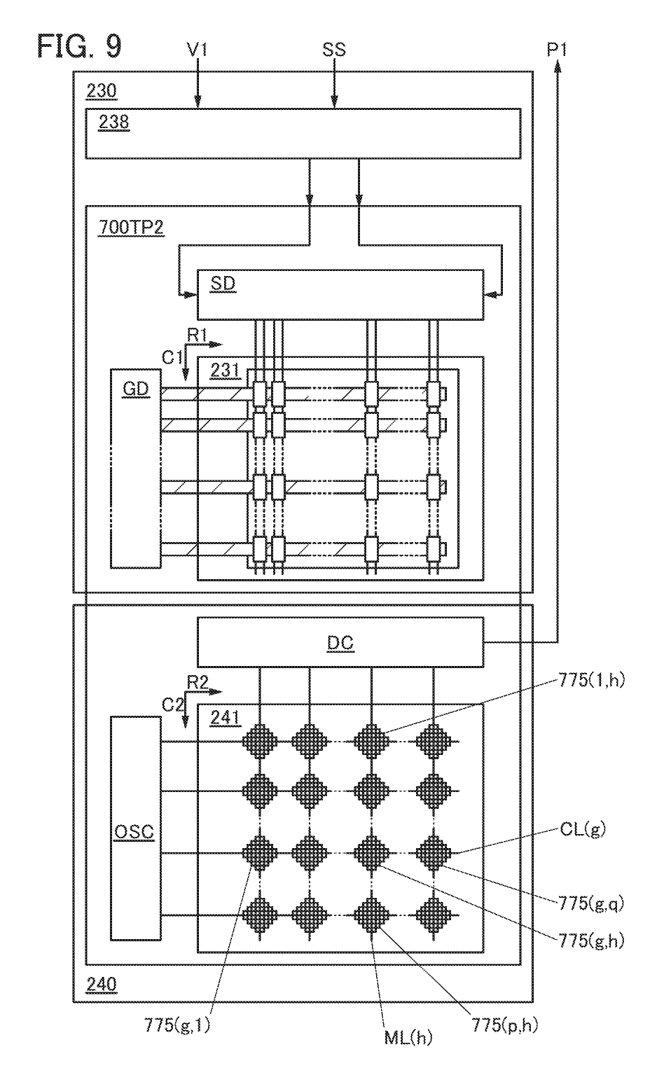

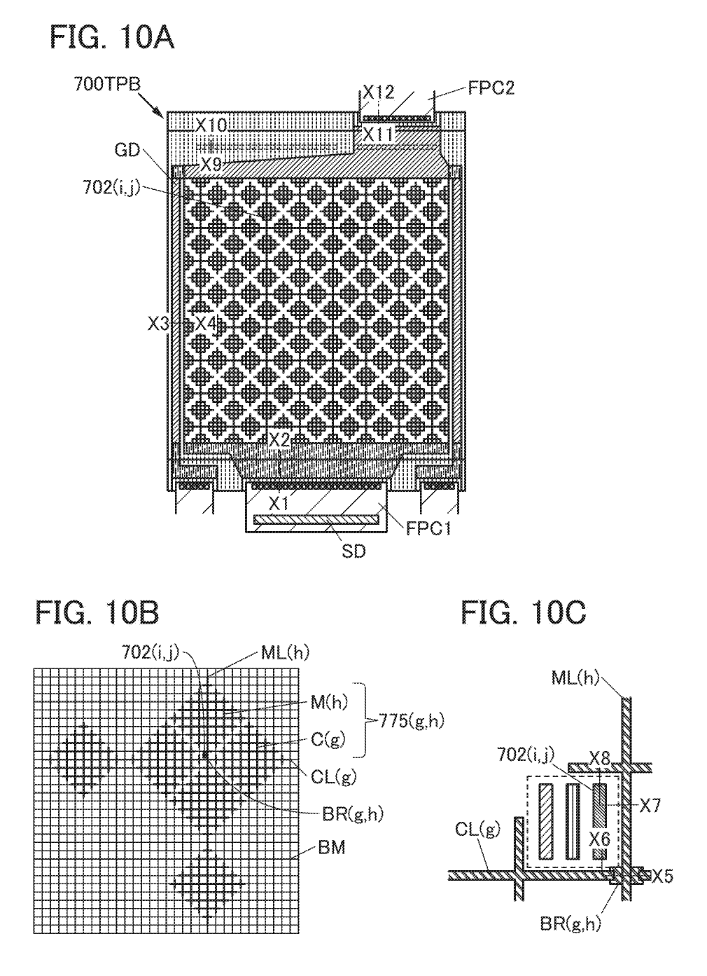

In this embodiment, a structure of an input/output device of one embodiment of the present invention will be described with reference to FIG. 9, FIGS. 10A to 10C, FIGS. 11A and 11B, and FIG. 12.

FIG. 9 is a block diagram illustrating a structure of an input portion of the input/output device of one embodiment of the present invention.

FIGS. 10A to 10C illustrate a structure of an input/output panel that can be used for an input/output device of one embodiment of the present invention. FIG. 10A is a top view of the input/output panel. FIG. 10B is a schematic view illustrating part of an input portion of the input/output panel of one embodiment of the present invention. FIG. 10C is a schematic view illustrating part of FIG. 10B. FIG. 10C is a schematic view illustrating a structure of the pixel 702(i,j) that can be used for the input/output device.

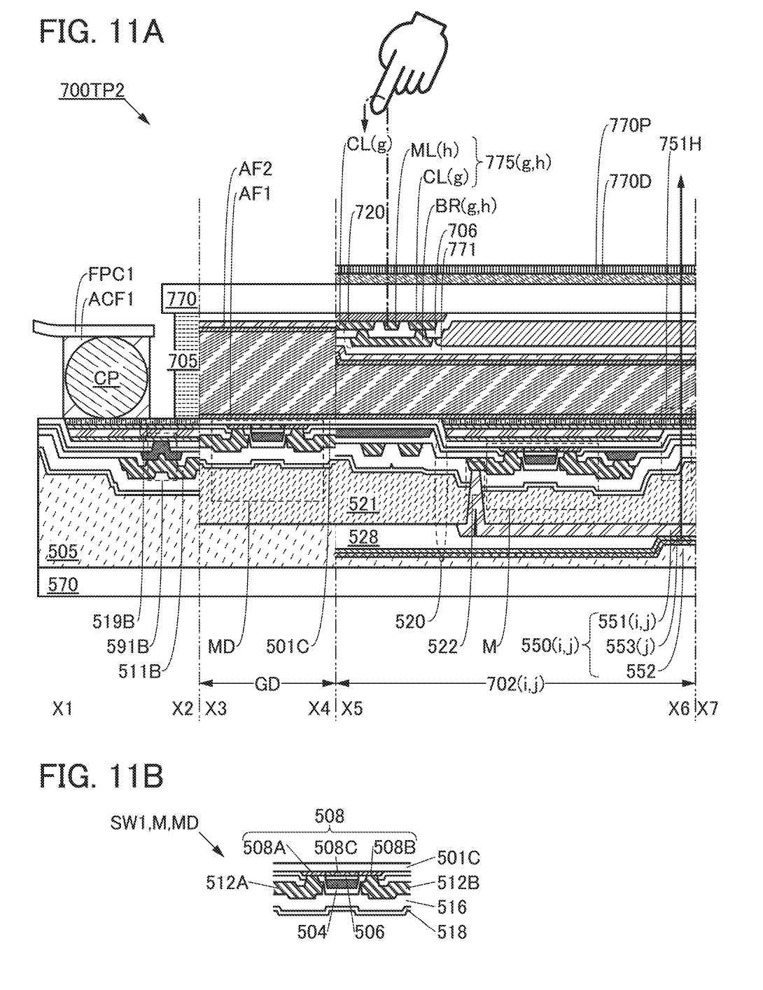

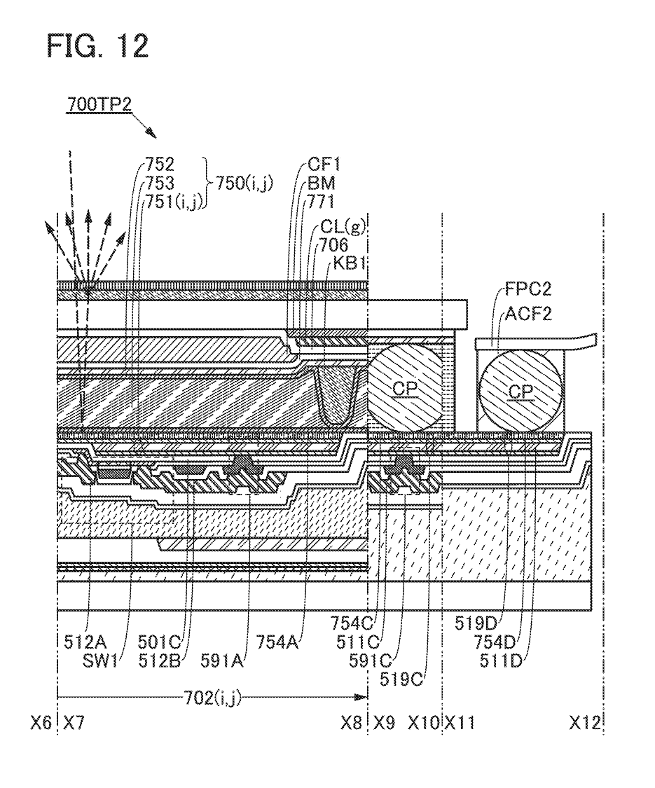

FIGS. 11A and 11B and FIG. 12 illustrate a structure of an input/output panel that can be used for an input/output device of one embodiment of the present invention. FIG. 11A is a cross-sectional view taken along lines X1-X2 and X3-X4 in FIG. 10A and line X5-X6 in FIG. 10C. FIG. 11B is a cross-sectional view illustrating part of the structure illustrated in FIG. 11A.

FIG. 12 is a cross-sectional view taken along line X7-X8 in FIG. 10C and lines X9-X10 and X11-X12 in FIG. 10A.

### <Structure Example of Input/Output Device>

The input/output device illustrated in this embodiment includes a display portion 230 and an input portion 240 (see FIG. 9). The input/output device includes an input/output panel 700TP2.

The input portion 240 includes a sensor region 241, and the sensor region 241 includes a region overlapping with the display region 231 in the display portion 230. The sensor region 241 has a function of sensing an object approaching a region overlapping with the display region 231 (see FIG. 11A).

### <<Input Portion 240>>

The input portion 240 includes the sensor region 241, an oscillator circuit OSC, and a sensor circuit DC (see FIG. 9).

The sensor region 241 includes one group of sensor elements 775(g,1) to 775(g,q) and another group of sensor elements 775(1,h) to 775(p,h) (see FIG. 9). Note that g is an integer greater than or equal to 1 and less than or equal to p, h is an integer greater than or equal to 1 and less than or equal to q, and p and q are each an integer greater than or equal to 1.

The one group of sensor elements 775(g,1) to 775(g,q) include the sensor element 775(g,h) and are arranged in a row direction (indicated by the arrow R2 in the drawing). Note that the direction indicated by the arrow R2 in FIG. 9 may be the same as or different from the direction indicated by the arrow R1 in FIG. 9.

The another group of sensor elements 775(1,h) to 775(p,h) include the sensor element 775(g,h) and are provided in the column direction (the direction indicated by the arrow C2 in the drawing) that intersects the row direction.

The one group of sensor elements 775(g,1) to 775(g,q) provided in the row direction include an electrode C(g) that is electrically connected to a control line CL(g) (see FIG. 10C).

The another group of sensor elements 775(1,h) to 775(p,h) provided in the column direction include an electrode M(h) that is electrically connected to a sensor signal line ML(h).

The control line CL(g) includes a conductive film BR(g,h) (see FIG. 11A). The conductive film BR(g,h) includes a region overlapping with the sensor signal line ML(h).

An insulating film 706 includes a region sandwiched between the sensor signal line ML(h) and the conductive film BR(g,h). Thus, a short circuit between the sensor signal line ML(h) and the conductive film BR(g,h) can be prevented.

<<Sensor element 775(g,h)>>

The sensor element 775(g,h) is electrically connected to the control line CL(g) and the sensor signal line ML(h).

The sensor element 775(g,h) has a light-transmitting property. The sensor element 775(g,h) includes an electrode C(g) and an electrode M(h).

For example, a conductive film having an opening at a region overlapping with the pixel 702(i,j) can be used for the electrode C(g) and the sensor signal line ML(h). Accordingly, an object that comes in the vicinity of a region overlapping with the display panel can be sensed without disturbing display of the display panel. Furthermore, the thickness of the input/output device can be reduced. As a result, a novel input/output device with high convenience or high reliability can be provided.

The electrode C(g) is electrically connected to the control line CL(g).

The electrode M(h) is electrically connected to the sensor signal line ML(h) and is positioned so that an electric field part of which is blocked by an object approaching a region overlapping with the display panel 700 is generated between the electrode M(h) and the electrode C(g).

Note that the control line CL(g) has a function of supplying a control signal.

The sensor signal line ML(h) has a function of receiving the sensor signal.

The sensor element 775(g,h) has a function of supplying a sensor signal that changes in accordance with a control signal and a distance from an object approaching the region overlapping with the display panel 700.

Thus, the object approaching the region overlapping with the display device can be sensed while the image data is displayed by the display device. As a result, a novel input/output device with high convenience or high reliability can be provided.

### <<Oscillator Circuit OSC>>

The oscillator circuit OSC is electrically connected to the control line CL(g) and has a function of supplying a control signal. For example, a rectangular wave, a sawtooth wave, a triangular wave, or the like can be used as the control signal.

### <<Sensor Circuit DC >>

The sensor circuit DC is electrically connected to the sensor signal line ML(h) and has a function of supplying a sensor signal on the basis of a change in the potential of the sensor signal line ML(h). Note that the sensor signal includes a positional data P1, for example.

### <<Display Portion 230>>

For example, the display device described in Embodiment 1 can be used for the display portion 230.

### <<Input/Output Panel 700TP2>>

The input/output panel 700TP2 is different from the display panel 700 described in

Embodiment 2 in that the input/output panel 700TP2 includes a functional layer 720 and a top-gate transistor. Here, the different portions will be described in detail, and the above description is referred to for the other similar portions.

### <<Functional Layer 720>>

The functional layer 720 includes a region surrounded by the substrate 770, the insulating film 501C, and the sealant 705 (FIGS. 11A and 11B and FIG. 12).

The functional layer 720 includes the control line CL(g), the sensor signal line ML(h), and the sensor element 775(g,h).

The gap between the control line CL(g) and the second electrode 752 or between the sensor signal line ML(h) and the second electrode 752 is greater than or equal to 0.2 μm and less than or equal to 16 μm, preferably greater than or equal to 1 μm and less than or equal to 8 μm, further preferably greater than or equal to 2.5 μm and less than or equal to 4 μm.

### <<Conductive Film 511D>>

The input/output panel 700TP2 described in this embodiment includes the conductive film 511D (see FIG. 12).

Note that the conductive material CP or the like can be provided between the control line CL(g) and the conductive film 511D to electrically connect the control line CL(g) and the conductive film 511D. Alternatively, the conductive material CP or the like can be provided between the sensor signal line ML(h) and the conductive film 511D to electrically connect the sensor signal line ML(h) and the conductive film 511D. A material that can be used for the wiring or the like can be used for the conductive film 511D, for example.

### <<Terminal 519D>>

The input/output panel 700TP2 described in this embodiment includes a terminal 519D. The terminal 519D is electrically connected to the conductive film 511D.

The terminal 519D is provided with the conductive film 511D and an intermediate film 754D, and the intermediate film 754D includes a region in contact with the conductive film 511D.

A material that can be used for the wiring or the like can be used for the terminal 519D, for example. Specifically, the terminal 519D can have the same structure as the terminal 519B or the terminal 519C (see FIG. 12).

Note that the terminal 519D can be electrically connected to the flexible printed circuit FPC2 using the conductive material ACF2, for example. Thus, a control signal can be supplied to the control line CL(g) with use of the terminal 519D, for example. Alternatively, a sensor signal can be supplied from the sensor signal line ML(h) with use of the terminal 519D.

### <<Switch SW1, Transistor M, Transistor MD>>

A transistor that can be used as the switch SW1, the transistor M, and the transistor MD each include the conductive film 504 having a region overlapping with the insulating film 501C and the semiconductor film 508 having a region sandwiched between the insulating film 501C and the conductive film 504. Note that the conductive film 504 functions as a gate electrode (see FIG. 11B).

The semiconductor film 508 includes a first region 508A, a second region 508B, and a third region 508C. The first region 508A and the second region 508B do not overlap with the conductive film 504. The third region 508C is positioned between the first region 508A and the second region 508B and overlaps with the conductive film 504.

The transistor MD includes the insulating film 506 between the third region 508C and the conductive film 504. Note that the insulating film 506 functions as a gate insulating film.

The first region 508A and the second region 508B have a lower resistivity than the third region 508C, and function as a source region and a drain region.

For example, an oxide semiconductor film is subjected to plasma treatment using a gas including a rare gas, so that the first region 508A and the second region 508B can be formed in the semiconductor film 508.

For example, the conductive film 504 can be used for a mask. Thus, part of the third region 508C can be formed into a shape of an end of the conductive film 504 in a self-aligned manner.

The transistor MD includes the conductive film 512A and the conductive film 512B that are in contact with the first region 508A and the second region 508B, respectively. The conductive film 512A and the conductive film 512B function as a source electrode and a drain electrode.

A transistor that can be fabricated in the same process as the transistor MD can be used as the transistor M, for example.

This embodiment can be combined with any other embodiment as appropriate.

### Embodiment 4

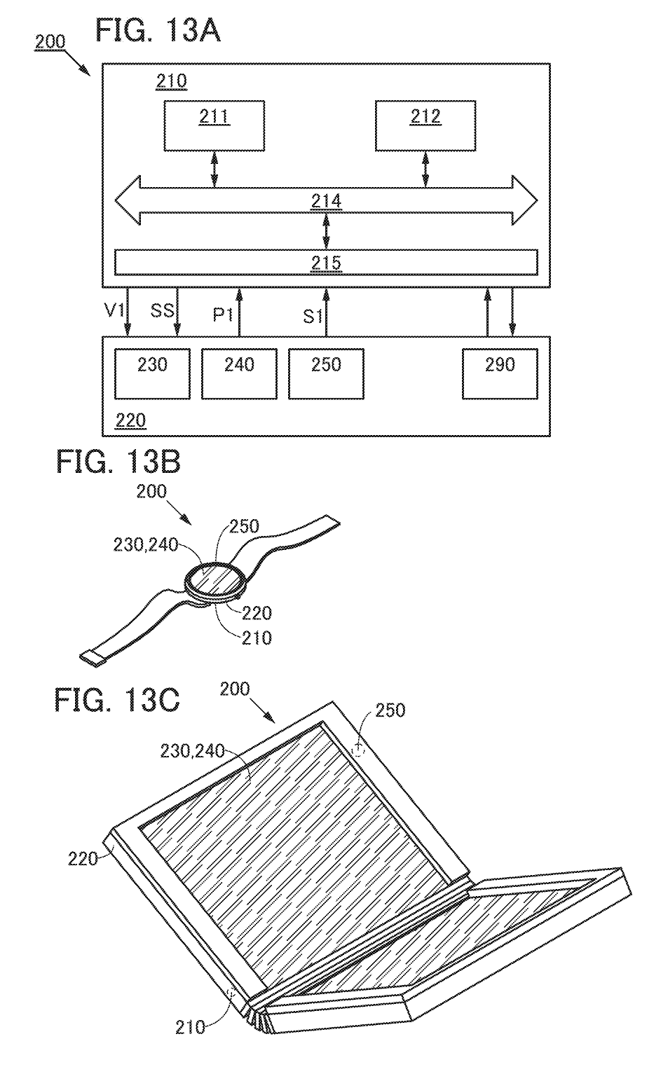

In this embodiment, a structure of a data processing device of one embodiment of the present invention will be described with reference to FIGS. 13A to 24F.

FIG. 13A is a block diagram illustrating a structure of the data processing device of one embodiment of the present invention. FIGS. 13B and 13C are each a projection view illustrating an example of an external view of a data processing device 200.

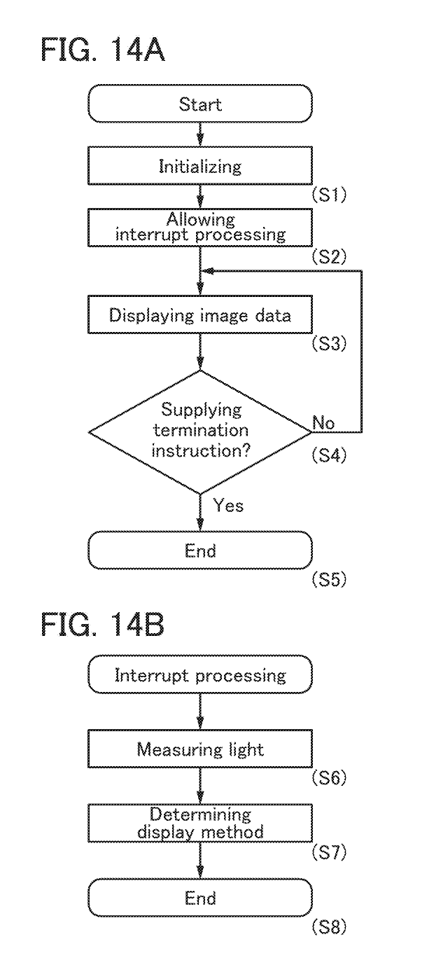

FIGS. 14A and 14B are flow charts showing a program of one embodiment of the present invention. FIG. 14A is a flow chart showing main processing of the program of one embodiment of the present invention. FIG. 14B is a flow chart showing interrupt processing.

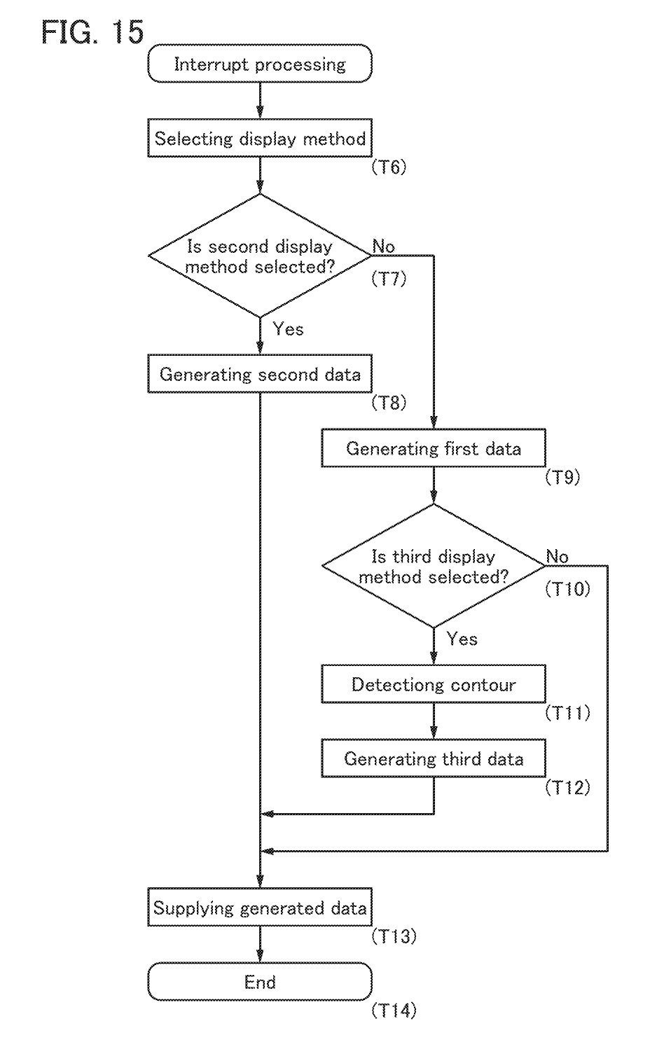

FIG. 15 is a flow chart showing interrupt processing of the program of one embodiment of the present invention.

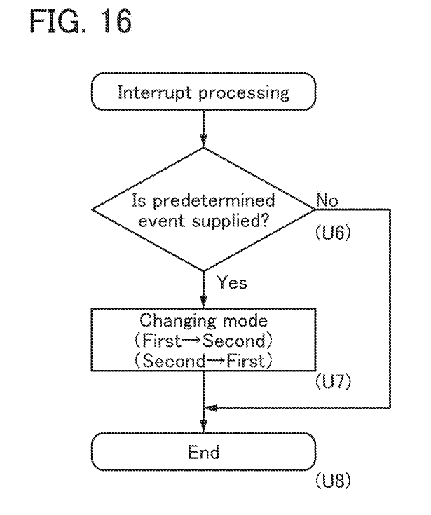

FIG. 16 is a flow chart showing interrupt processing of the program of one embodiment of the present invention.

### <Structure Example 1 of Data Processing Device>

The data processing device 200 described in this embodiment includes an input/output device 220 and an arithmetic device 210 (see FIG. 13A). The input/output device 220 is electrically connected to the arithmetic device 210. The data processing device 200 can include a housing (see FIG. 13B or 13C).

The input/output device 220 includes the display portion 230 and the input portion 240 (see FIG. 13A). The input/output device 220 includes a sensor portion 250. The input/output device 220 can include a communication portion 290.

The input/output device 220 has a function of receiving the image data V1 or the control data SS and a function of supplying the positional data P1 or sensing data S1.

The arithmetic device 210 has a function of receiving the positional data P1 or the sensing data S1. The arithmetic device 210 has a function of supplying the image data V1. For example, the arithmetic device 210 has a function of operating on the basis of the positional data P1 or the sensing data S1.

Note that the housing has a function of storing the input/output device 220 or the arithmetic device 210. Alternatively, the housing has a function of supporting the display portion 230 or the arithmetic device 210.

The display portion 230 has a function of displaying an image on the basis of the image data V1. The display portion 230 has a function of displaying an image on the basis of the control data SS.

The input portion 240 has a function of supplying the positional data P1.

The sensor portion 250 has a function of supplying the sensing data S1. The sensor portion 250 has a function of sensing the illuminance of the environment where the data processing device 200 is used and a function of supplying illuminance data, for example. The sensor portion 250 has a function of sensing the chromaticity of ambient light in the environment where the data processing device 200 is used and a function of supplying illuminance data, for example.

Thus, the data processing device can identify the intensity of light received by the housing of the data processing device and operate under a usage environment. As a result, a novel data processing device with high convenience or high reliability can be provided.

Accordingly, a user of the data processing device can select a display method. Specifically, when a display method using the first display element is selected, power consumption can be reduced, for example. When a display method using the second display element is selected, an image can be displayed in a dark place, for example. When a display method using the first display element and the second display element is selected, text data can be displayed with an increase in the visibility as compared with the case of using only the first display element. Alternatively, a schematic view can be displayed with an increase in the visibility as compared with the case of using only the first display element. Further alternatively, a sharp and clear image can be displayed as compared with the case of using only the first display element. As a result, a novel data processing device with high convenience or high reliability can be provided.

Individual components included in the data processing device will be described below. Note that these components cannot be clearly distinguished and one component may also serve as another component or include part of another component. For example, a touch panel in which a touch sensor is provided so as to overlap with a display panel serves as an input portion as well as a display portion.

### <<Structure Example>>

The data processing device 200 of one embodiment of the present invention includes a housing or the arithmetic device 210.

The arithmetic device 210 includes an arithmetic portion 211, a memory portion 212, a transmission path 214, or an input/output interface 215.

The data processing device of one embodiment of the present invention includes the input/output device 220.

The input/output device 220 includes the display portion 230, the input portion 240, the sensor portion 250, and the communication portion 290.

### <<Data Processing Device>>

The data processing device of one embodiment of the present invention includes the arithmetic device 210 or the input/output device 220.

### <<Arithmetic Device 210>>

The arithmetic device 210 includes the arithmetic portion 211 and the memory portion 212. The arithmetic device 210 further includes the transmission path 214 and the input/output interface 215.

### <<Arithmetic Portion 211>>

The arithmetic portion 211 has a function of executing a program, for example.

### <<Memory Portion 212>>

The memory portion 212 has a function of, for example, storing the program executed by the arithmetic portion 211, initial data, setting data, an image, or the like.

Specifically, a hard disk, a flash memory, a memory including a transistor formed using an oxide semiconductor, or the like can be used.

### <<Input/Output Interface 215, Transmission Path 214>>

The input/output interface 215 includes a terminal or a wiring and has a function of supplying and receiving data. For example, the input/output interface 215 can be electrically connected to the transmission path 214 and the input/output device 220.

The transmission path 214 includes a wiring and has a function of supplying and receiving data. For example, the transmission path 214 can be electrically connected to the arithmetic portion 211, the memory portion 212, or the input/output interface 215.

### <<Input/Output Device 220>>

The input/output device 220 includes the display portion 230, the input portion 240, the sensor portion 250, or a communication portion 290. For example, the input/output device described in Embodiment 3 can be used. Accordingly, power consumption can be reduced.

### <<Display Portion 230>>

The display portion 230 includes the control portion 238, the driving circuit GD, the driving circuit SD, and the display panel 700 (see FIG. 1). For example, the display device described in Embodiment 1 can be used as the display portion 230.

### <<Input Portion 240>>

A variety of human interfaces or the like can be used as the input portion 240 (see FIGS. 13A to 13C).

For example, a keyboard, a mouse, a touch sensor, a microphone, a camera, or the like can be used as the input portion 240. Note that a touch sensor having a region overlapping with the display portion 230 can be used. An input/output device that includes the display portion 230 and a touch sensor having a region overlapping with the display portion 230 can be referred to as a touch panel or a touch screen.

For example, a user can make various gestures (e.g., tap, drag, swipe, and pinch in) using his/her finger as a pointer on the touch panel.

The arithmetic device 210, for example, analyzes data on the position, track, or the like of the finger on the touch panel and determines that a specific gesture is supplied when the analysis results meet predetermined conditions. Therefore, the user can supply a predetermined operation instruction associated with a predetermined gesture by using the gesture.

For instance, the user can supply a “scrolling instruction” for changing a portion where image data is displayed by using a gesture of touching and moving his/her finger on the touch panel.

### <<Sensor Portion 250>>

The sensor portion 250 has a function of sensing the surroundings and supplying the sensing data such as illuminance data, attitude data, pressure data, and positional data.

For example, a photosensor, an attitude sensor, an acceleration sensor, a direction sensor, a global positioning system (GPS) signal receiving circuit, a pressure sensor, a temperature sensor, a humidity sensor, a camera, or the like can be used as the sensor portion 250.

### <<Communication Portion 290>>

The communication portion 290 has a function of supplying and acquiring data to/from a network.

### <<Program>>

The program of one embodiment of the present invention has the following steps (see FIG. 14A).

### [First Step]

In a first step, setting is initialized (see S1 in FIG. 14A).

For example, predetermined image data which is to be displayed on start-up, a predetermined mode of displaying the image data, and a predetermined method of displaying the image data are acquired from the memory portion 212. Specifically, one still image data or another moving image data can be used as the predetermined image data. Furthermore, a first mode or a second mode can be used as the predetermined mode. Furthermore, a first display method, a second display method, or a third display method can be used as the predetermined display method.

### [Second Step]

In a second step, interrupt processing is allowed (see S2 in FIG. 14A). Note that an arithmetic device allowed to execute the interrupt processing can perform the interrupt processing in parallel with the main processing. The arithmetic device that has returned from the interrupt processing to the main processing can reflect the results of the interrupt processing in the main processing.

The arithmetic device may execute the interrupt processing when a counter has an initial value, and the counter may be set at a value other than the initial value when the arithmetic device returns from the interrupt processing. Thus, the interrupt processing is ready to be executed after the program is started up.

### [Third Step]

In a third step, image data is displayed in the predetermined mode or with the predetermined display method selected in the first step or the interrupt processing (see S3 in FIG. 14A). Note that the predetermined mode identifies a mode for displaying the data, and the predetermined display method identifies a method for displaying image data. For example, the image data V1, the data V11, or the data V12 can be used for data to be displayed, for example.

For example, a method for displaying the image data V1 can be associated with the first mode. Another method for displaying the image data V1 can be associated with the second mode. Thus, a display method can be selected on the basis of the selected mode.

For example, three different methods for displaying the image data V1 can be associated with the first display method to the third display method. Thus, display can be performed on the basis of the selected display method.

### <<First Mode>>

Specifically, a method of supplying selection signals to a scan line at a frequency of 30 Hz or more, preferably 60 Hz or more, and displaying an image in accordance with the selection signals can be associated with the first mode.

For example, the supply of selection signals at a frequency of 30 Hz or more, preferably 60 Hz or more, can display a smooth moving image.

For example, an image is refreshed at a frequency of 30 Hz or more and preferably 60 Hz or more, so that an image smoothly following the user's operation can be displayed on the data processing device 200 the user is operating.

### <<Second Mode>>

Specifically, a method for supplying selection signals to a scan line at a frequency less than 30 Hz, preferably less than 1 Hz, further preferably once a minute and displaying an image in accordance with the selection signals can be associated with the second mode.

The supply of selection signals at a frequency of less than 30 Hz, preferably less than 1 Hz, further preferably once a minute, enables an image to be displayed with flickers reduced. Furthermore, power consumption can be reduced.

For example, when the data processing device 200 is used for a clock or watch, the display can be refreshed at a frequency of once a second, once a minute, or the like.

For example, when a light-emitting element is used as the second display element, the light-emitting element can be configured to emit light in a pulsed manner so as to display image data. Specifically, an organic EL element can be configured to emit light in a pulsed manner, and its afterglow can be used for display. The organic EL element has excellent frequency characteristics; thus, time for driving the light-emitting element can be shortened, and thus power consumption can be reduced in some cases. Alternatively, heat generation can be inhibited, and thus the deterioration of the light-emitting element can be suppressed in some cases.

### <<First Display Method>>

Specifically, a method in which the first display element 750(i,j) is used to display image data can be used as the first display method. Thus, for example, the power consumption can be reduced. In addition, image data with high contrast can be favorably displayed in a bright environment.

### <<Second Display Method>>

Specifically, a method in which the second display element 550(i,j) is used to display image data can be used as the second display method. Thus, for example, an image can be favorably displayed in a dark environment. Alternatively, a photograph and the like can be displayed with favorable color reproducibility. Alternatively, a moving image which moves quickly can be displayed smoothly.

In the case where the image data V1 is displayed using the second display element 550(i,j), brightness for displaying the image data V1 can be determined on the basis of illuminance data. For example, when illuminance is higher than or equal to 5,000 lux and less than 100,000 lux, the image data V1 is displayed using the second display element 550(i,j) to be brighter than the case where the illuminance is less than 5,000 lux.

### <<Third Display Method>>

Specifically, a method in which the first display element 750(i,j) and the second display element 550(i,j) are used to display image data can be used as the third display method. In that case, power consumption can be reduced. Thus, for example, an image can be favorably displayed in a dark environment. Alternatively, a photograph and the like can be displayed with favorable color reproducibility. Alternatively, a moving image which moves quickly can be displayed smoothly.

Note that a function of adjusting the brightness of display by using the first display element 750(i,j) and the second display element 550(i,j) for display can be referred to as a light adjusting function. For example, the brightness of a reflective display element can be compensated using the display element having a function of emitting light.

Note that a function of adjusting the color of display by using the first display element 750(i, j) and the second display element 550(i, j) can be referred to as a color adjusting function. For example, the color of a reflective display element can be changed using the display element having a function of emitting light. Specifically, the use of a blue organic EL element can make a yellowish color displayed by the reflective liquid crystal element closer to white. Thus, text data can be displayed like texts printed on a plain paper, for example. Alternatively, an eye-friendly display can be achieved.

### [Fourth Step]

In a fourth step, the program is determined to proceed to a fifth step when a termination instruction is supplied, whereas the program is determined to proceed to the third step when the termination instruction is not supplied (see S4 in FIG. 14A).

For example, the termination instruction supplied in the interrupt processing can be used to determine the next step.

### [Fifth Step]

In the fifth step, the program terminates (see S5 in FIG. 14A).

### <<Interrupt Processing>>

The interrupt processing includes sixth to eighth steps described below (see FIG. 14B).

### [Sixth Step]

In the sixth step, the illuminance of the environment where the data processing device 200 is used can be sensed using the sensor portion 250, for example (see S6 in FIG. 14B). Note that color temperature or chromaticity of ambient light can be sensed instead of the illuminance of the environment.

### [Seventh Step]

In the seventh step, a display method is determined on the basis of the sensed illuminance data. For example, the first display method is determined when the illuminance is greater than or equal to the predetermined value, whereas the second display method is determined when the illuminance is less than the predetermined value. Alternatively, the display method may be determined to be the third display method when the illuminance is within a predetermined range (see S7 in FIG. 14B).

Specifically, in the case where the illuminance is greater than or equal to 100,000 lux, the first display method may be determined to be used. In the case where the illuminance is less than 5,000 lux, the second display method may be determined to be used. In the case where the illuminance is greater than or equal to 5,000 lux and less than 100,000 lux, the third display method may be determined to be used.

In the case where color temperature or chromaticity of the ambient light is sensed in the sixth step, the color of display may be adjusted using the second display element 550(i,j) by the third display method.

For example, the first-status control data SS is supplied when the first display method is used, the second-status control data SS is supplied when the second display method is used, and the third-status control data SS is supplied when the third display method is used.

### [Eighth Step]

In the eighth step, the interrupt processing terminates (see S8 in FIG. 14B).

### <Structure Example 2 of Data Processing Device>

Another structure of a data processing device of one embodiment of the present invention will be described with reference to FIG. 15.

FIG. 15 is a flow chart showing the program of one embodiment of the present invention. The interrupt processing in the flow chart in FIG. 15 is different from that in FIG. 14B.

Note that the structure example 2 of the data processing device is different from the interrupt processing in FIG. 14B in that the interrupt processing includes a step of setting the display method manually, a step of generating first to third data on the basis of the set display method, and a step of supplying the generated data. The different portions will be described in detail, and the above description is referred to for the other similar portions.

### <<Interrupt Processing>>

The interrupt processing includes sixth to fourteenth steps described below (see FIG. 15).

### [Sixth Step]

In the sixth step, a display method is selected. For example, the first to third display methods are manually set (see T6 in FIG. 15).

Specifically, a predetermined event associated with an instruction for setting a display mode may be used.

### [Seventh Step]

In the seventh step, the program is determined to proceed to the eighth step when the second display method is selected, whereas the program is determined to proceed to the ninth step when the second display method is not set to use (see T7 in FIG. 15).

Specifically, the program is determined to proceed to the ninth step when the first display method or the third display method is selected.

### [Eighth Step]

In the eighth step, the second data V12 is generated on the basis of the image data V1, and then the program proceeds to the thirteenth step. For example, the data V12 is generated with use of the image processing circuit 235M so that the second display element displays a favorable image (see T8 in FIG. 15).

### [Ninth Step]

In the ninth step, the first data V11 is generated on the basis of the image data V1. For example, the data V11 is generated with use of the image processing circuit 235M so that the first display element displays a favorable image (see T9 in FIG. 15).

### [Tenth Step]

In the tenth step, the program is determined to proceed to the eleventh step when the third display method is selected, whereas the program is determined to proceed to the thirteenth step when the third display method is not selected (see T10 in FIG. 15).

Specifically, the program is determined to proceed to the thirteenth step when the first display method is selected.

### [Eleventh Step]

In the first eleventh step, a contour is detected from the image data V1. For example, the contour is detected from the image data V1 with use of the image processing circuit 235M (see T11 in FIG. 15).

### [Twelfth Step]

In the twelfth step, the third data V13 in which the contour portion is emphasized is generated, and then the program proceeds to the thirteenth step. For example, the data V13 is generated with use of the image processing circuit 235M (see T12 in FIG. 15).

### [Thirteenth Step]

In the thirteenth step, the generated data is supplied (see T13 in FIG. 15).

Specifically, the second data V12 is supplied when the second data V12 has been generated in the eighth step. Alternatively, the first data V11 is supplied when the first data V11 has been generated in the ninth step. Alternatively, the first data V11 and the third data V13 are supplied when the first data V11 has been generated in the ninth step and the third data V13 has been generated in the twelfth step.

### [Fourteenth Step]

In the fourteenth step, the interrupt processing terminates (see T14 in FIG. 15).

Thus, the user of the data processing device can select a display method. Specifically, when the display method using the first display element is selected, power consumption can be reduced, for example. When a display method using the second display element is selected, an image can be displayed in a dark place, for example. When a display method using the first display element and the second display element is selected, text data can be displayed with an increase in the visibility as compared with the case of using only the first display element. Alternatively, a schematic view can be displayed with an increase in the visibility as compared with the case of using only the first display element. Further alternatively, a sharp and clear image can be displayed as compared with the case of using only the first display element. As a result, a novel method for displaying image data of a data processing device with high convenience or high reliability can be provided.

### <<Predetermined Event>>

For example, the following events can be used: events supplied using a pointing device such as a mouse (e.g., “click” and “drag”) and events supplied to a touch panel with a finger or the like used as a pointer (e.g., “tap”, “drag”, or “swipe”).

For example, the position of a slide bar pointed by a pointer, the swipe speed, and the drag speed can be used as parameters assigned to an instruction associated with the predetermined event.

For example, data sensed by the sensor portion 250 is compared to a threshold set in advance, and the compared results can be used for the event.

Specifically, a pressure sensor or the like in contact with a button that can be pushed in a housing or the like, can be used as the sensor portion 250.

<<Instruction Associated with Predetermined Event>>

For example, the termination instruction can be associated with a predetermined event.

For example, “page-turning instruction” for switching displayed image data from one to another can be associated with a predetermined event. Note that a parameter for determining the page-turning speed or the like when the “page-turning instruction” is executed can be supplied using the predetermined event.

For example, “scroll instruction” for moving the display position of part of image data and displaying another part continuing from that part can be associated with a predetermined event. Note that a parameter for determining the moving speed of the display position or the like when the “scroll instruction” is executed can be supplied using the predetermined event.

For example, an instruction for setting a display method or an instruction for generating image data can be associated with a predetermined event. Note that a parameter for determining the brightness of a generated image can be associated with a predetermined event. Furthermore, a parameter for determining the brightness of a generated image may be determined on the basis of ambient luminance sensed by the sensor portion 250.

For example, an instruction or the like for acquiring data distributed via a push service using the communication portion 290 can be associated with a predetermined event.

Note that positional data sensed by the sensor portion 250 may be used for the determination of the presence or absence of a qualification for acquiring data. Specifically, it may be determined that there is a qualification for acquiring data when the user is in a predetermined class room, school, conference room, office, or building. For example, educational materials can be fed from a classroom of, for example, a school or a university and displayed, so that the data processing device 200 can be used as a schoolbook or the like (see FIG. 13C). Alternatively, materials distributed from a conference room in, for example, a company can be received and used for the conference materials.

### <Structure Example 3 of Data Processing Device>

Another structure of the data processing device of one embodiment of the present invention will be described with reference to FIG. 16.

FIG. 16 is a flow chart showing the program of one embodiment of the present invention. The flow chart in FIG. 16 shows interrupt processing different from that shown in FIG. 14B.

Note that the structure example 3 of the data processing device is different from the interrupt processing in FIG. 14B in that the interrupt processing includes a step of changing a mode on the basis of a supplied predetermined event. Here, the different portions will be described in detail, and the above description is referred to for the other similar portions.

### <<Interrupt Processing>>

The interrupt processing includes sixth to eighth steps described below (see FIG. 16).

### <<Sixth Step>>

In the sixth step, the program is determined to proceed to the seventh step when a predetermined event is supplied, whereas the program is determined to proceed to the eighth step when the predetermined event is not supplied (see U6 in FIG. 16). For example, whether the predetermined event is supplied in a predetermined period or not can be a branch condition. Specifically, the predetermined period can be longer than 0 seconds and shorter than or equal to 5 seconds, preferably shorter than or equal to 1 second, further preferably shorter than or equal to 0.5 seconds, still further preferably shorter than or equal to 0.1 seconds.

### <<Seventh Step>>

In the seventh step, the mode is changed (see U7 in FIG. 16). Specifically, the mode is changed to the second mode when the first mode has been selected, or the mode is changed to the first mode when the second mode has been selected.

### <<Eighth Step>>

In the eighth step, the interrupt processing terminates (see U8 in FIG. 16). Note that in a period in which the main processing is executed, the interrupt processing may be repeatedly executed.

### <Structure Example 4 of Data Processing Device>

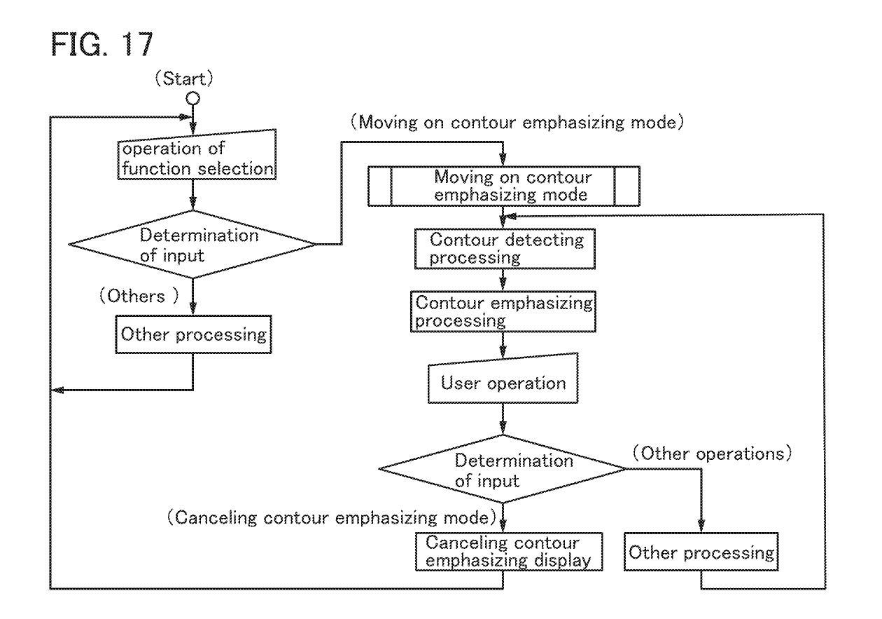

Another structure of the data processing device of one embodiment of the present invention will be described with reference to FIG. 17.

FIG. 17 is a flow chart showing the program of one embodiment of the present invention.

The data processing device includes a contour emphasizing mode that can be selected in accordance with operation by a user of the data processing device. When the contour emphasizing mode is selected, the program of the data processing data moves on the contour emphasizing mode. When the contour emphasizing mode is canceled, the contour emphasizing mode in the data processing device terminates (see FIG. 17).

In contour detecting processing, a contour portion is displayed with use of the second display element on the basis of the conditions of the contour portion and initial setting. Note that the initial setting conditions are set by the user of the data processing device or the like.

The data processing device has a function of emphasizing and displaying a portion corresponding to a contour of an image with use of the second display element. Thus, an increase in power consumption can be suppressed as much as possible, as compared with the case of a display device using an organic EL element. Alternatively, a sharp and clear image can be displayed with high visibility, as compared with the case of a display device using a reflective liquid crystal element.

For example, the data processing device has a function in which a user can select a method for detecting a contour in a manual manner or in an automatic manner in accordance with the image data V1. For example, the data processing device has a function in which a user can adjust the intensity of emphasizing a contour in a manual manner or in an automatic manner in accordance with the image data V1. Thus, detailed requirements can be satisfied. As a result, highly visible display and low power consumption can be balanced.

### <Structure Example 5 of Data Processing Device>

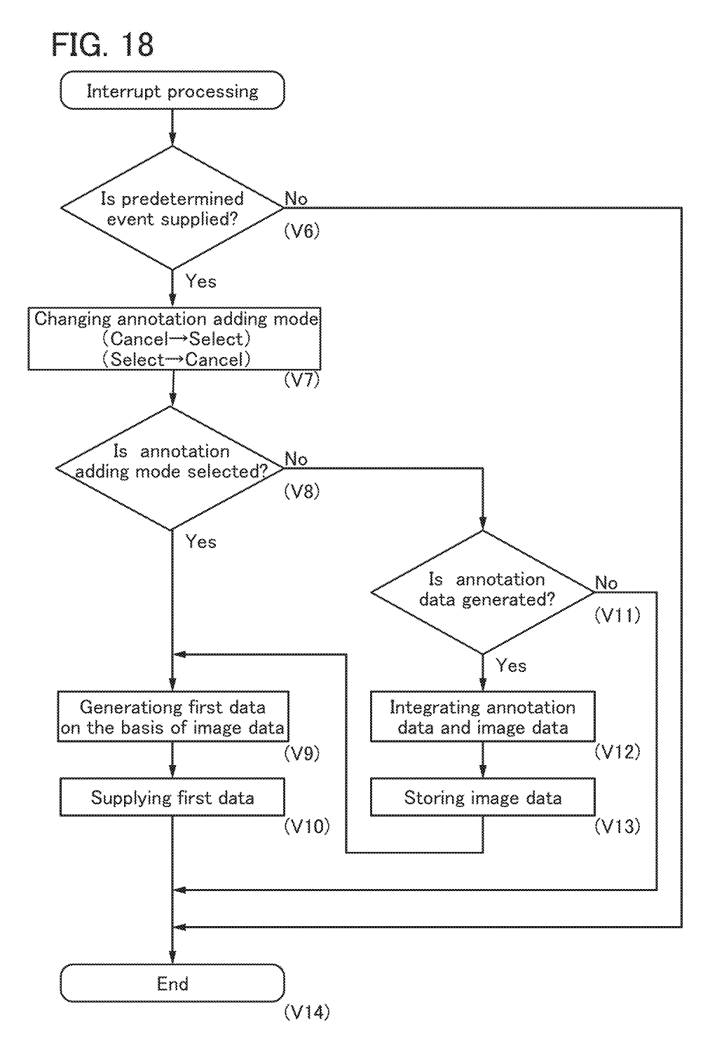

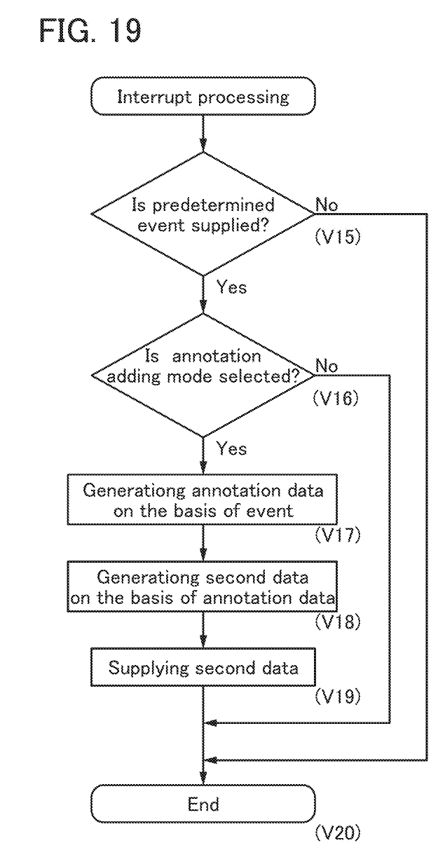

Another structure of the data processing device of one embodiment of the present invention will be described with reference to FIG. 18 and FIG. 19.

FIG. 18 and FIG. 19 are flow charts showing the program of one embodiment of the present invention. The flow chart in FIG. 18 shows interrupt processing different from that shown in FIG. 14B, and the flow chart shown in FIG. 19 shows interrupt processing different from those shown in FIG. 14B or FIG. 18.

Note that the structure example 5 of the data processing device is different from the interrupt processing in FIG. 14B in that the interrupt processing includes a step of setting or canceling an annotation adding mode, a step of integrating an annotation data and image data and storing the integrated data when the annotation adding mode is canceled, a step of supplying first data generated on the basis of the image data, a step of generating the annotation data on the bases of a predetermined event when the annotation adding mode is selected, and a step of supplying second data generated on the basis of the annotation data. Here, the different portions will be described in detail, and the above description is referred to for the other similar portions.

### <<First Interrupt Processing>>

First interrupt processing includes sixth to fourteenth steps described below (see FIG. 18).

### [Sixth Step]

In the sixth step, the program is determined to proceed to the seventh step when a predetermined event is supplied, whereas the program is determined to proceed to the fourteenth step when the predetermined event is not supplied (see V6 in FIG. 18).

Specifically, the annotation adding mode may be changed with use of the predetermined event associated in advance with an instruction for changing the annotation adding mode.

Note that the annotation adding mode indicates a state in which data can be added to the displayed image data V1. In other words, data such as an annotation, a supplementary note, an additional a note, a memo, an underline, or a highlight can be added in the annotation adding mode. Note that the image data V2 including annotation data includes data such as annotation, supplemental, additional note, memo, underline, or highlight.

### [Seventh Step]

In the seventh step, the annotation adding mode is changed (see V7 in FIG. 18). Specifically, the annotation adding mode is selected when the annotation adding mode has been canceled, whereas the annotation adding mode is canceled when the annotation adding mode has been selected.

### [Eighth Step]

In the eighth step, the program is determined to proceed to the ninth step when the annotation adding mode is selected, whereas the program is determined to proceed to the eleventh step when the annotation adding mode is not selected (see V8 in FIG. 18). Specifically, the program proceeds to the eleventh step when the annotation adding mode is canceled.

### [Ninth Step]

In the ninth step, the first data V11 is generated on the basis of the image data V1 (see V9 in FIG. 18). Specifically, the first data V11 is generated on the basis of the image data V1 at a time when the annotation adding mode is selected or on the basis of the updated image data V1 at a time when the annotation adding mode is canceled.

### [Tenth Step]

In the tenth step, the first data V11 is supplied (see V10 in FIG. 18).

### [Eleventh Step]

In the eleventh step, the program proceeds to the twelfth step when the image data V2 including annotation data is generated, whereas the program proceeds to the fourteenth step when the image data V2 including annotation data is note generated (see V11 in FIG. 18). Specifically, text data or a handwritten image supplied from an input portion or the like can be used as the image data V2 including annotation data.

Specifically, in a state where the annotation adding mode is not selected, the program is determined to proceed to the twelfth step when an annotation is added, whereas the program is determined to proceed to the fourteenth step when an annotation is not added.

### [Twelfth Step]

In the twelfth step, the image data V2 including annotation data and the image data V1 are integrated, so that the image data V1 is updated. Specifically, the image data V1 and the image data V2 including annotation data are calculated, so that the image data V1 is newly generated. For example, the image data V2 including annotation data for one pixel may be added to the pixel to which the image data V1 has been written, so that the data on the pixel may be updated.

### [Thirteenth Step]

In the thirteenth step, the image data V1 is stored, and then the program proceeds to the ninth step. Specifically, the updated image data V1 is stored in the memory portion.

### [Fourteenth Step]

In the fourteenth step, the first interrupt processing terminates.

### <<Second Interrupt Processing>>

The second interrupt processing includes fifteenth to twentieth steps described below (see FIG. 19).

### [Fifteenth Step]

In the fifteenth step, the program is determined to proceed to the sixteenth step when a predetermined event is supplied, whereas the program is determined to proceed to the twentieth step when the predetermined event is not supplied (see V15 in FIG. 19).

### [Sixteenth Step]

In the sixteenth step, the program is determined to proceed to the seventeenth step when the annotation adding mode is selected, whereas the program is determined to proceed to the twentieth step when the annotation adding mode is not selected (see V16 in FIG. 19). Specifically, the program proceeds to the twentieth step when the annotation adding mode is canceled.

### [Seventeenth Step]

In the seventeenth step, the image data V2 including annotation data is generated on the basis of the event (see V17 in FIG. 19). For example, positional data or text data supplied from the input portion can be used as the image data V2 including annotation data.

Specifically, the image data V2 including annotation data that is a figure shape can be generated on the basis of a trace of the positional data successively supplied. The image data V2 including annotation data including text data supplied from a keyboard or the like can be generated.

### [Eighteenth Step]

In the eighteenth step, the second data V12 is generated on the basis of the image data V2 including annotation data (see V18 in FIG. 19).

### [Nineteenth Step]

In the nineteenth step, the second data V12 is supplied (see V19 in FIG. 19).

### [Twentieth Step]

In the twentieth step, the second interrupt processing terminates (see V20 in FIG. 19).

Thus, the data processing device can generate the annotation data, for example, on the basis of the event supplied by a user of the data processing device. Alternatively, the data processing device displays the annotation data. Further alternatively, the generated annotation data can be added to the image data. Consequently, a novel method for displaying image data and adding annotation of a data processing device with high convenience or high reliability can be provided.

### <Structure Example 6 of Data Processing Device>

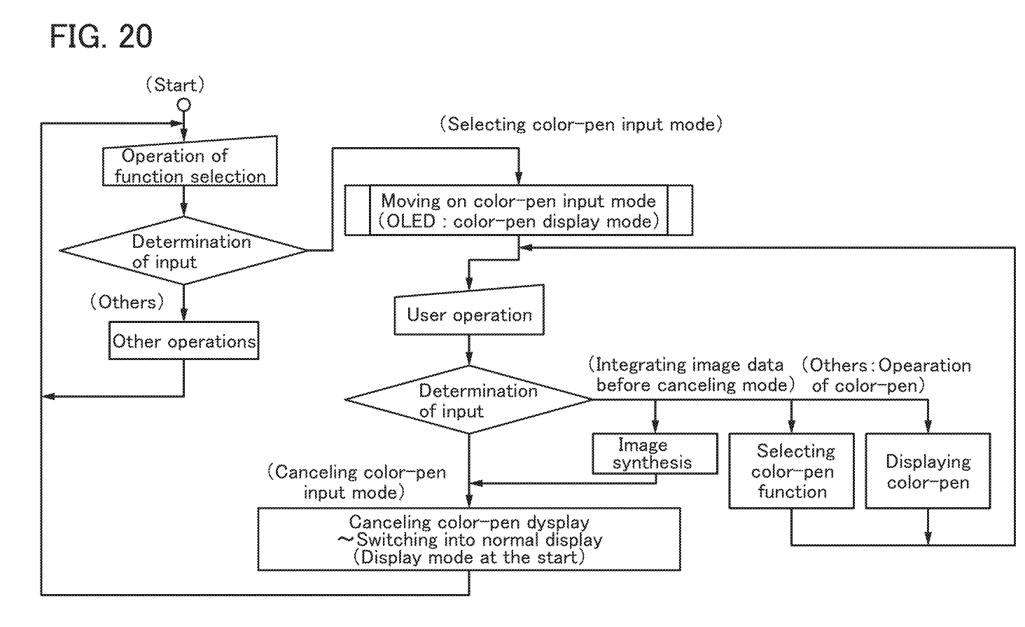

Another structure of the data processing device of one embodiment of the present invention will be described with reference to FIG. 20.

FIG. 20 is a flow chart showing the program of one embodiment of the present invention.

The data processing device includes a color-pen input mode that can be selected on the basis of operation by a user of the data processing device. When the color-pen input mode is selected, the program of the data processing device moves on the color-pen input mode. Alternatively, when the color-pen input mode is canceled, the color-pen input mode of the data processing device terminates (see FIG. 20).

### <<Method for Displaying Image Data V1>>

The data processing device of one embodiment of the present invention can display the image data V1 with use of the first display element 750(i,j).

For example, a reflective liquid crystal display element can be used as the first display element 750(i,j). Furthermore, with use of the second mode described in the structure example 1 of data processing device, for example, the image data V1 can be displayed while a selection signal is supplied at a low frequency. Accordingly, power consumption can be reduced.

### <<Method for Displaying Image Data V2 Including Annotation Data>>

The data processing device of one embodiment of the present invention can generate annotation data such as a figure drawn on the basis of user operation in the color-pen input mode. In addition, the generated annotation data can be displayed with use of the second display element 550(i,j).

For example, an organic EL element can be used as the second display element 550(i,j). For example, the image data V2 including annotation data is displayed with use of the second display element 550(i,j) at a luminance lowered to such a level as to allow the image data V1 to be displayed with use of the first display element 750(i,j). Thus, without a process of integrating the image data V1 and the image data V2 including annotation data, the image data V2 including annotation data can be drawn to be superimposed on the image data V1. Furthermore, the image data V2 including annotation data can be displayed, for example, as an image drawn with a semi-transparent color pen. As a result, the load of the circuit operation can be reduced. Furthermore, power consumption can be reduced.

Furthermore, for example, with use of the first mode described in the structure example 1 of the data processing device, the image data V2 including annotation data can be displayed while a selection signal is supplied at a high frequency. Thus, the annotation data can be displayed by following the user operation smoothly.

In the data processing device of one embodiment of the present invention, the color-pen input mode can be canceled on the basis of the user operation. Alternatively, a color-pen function can be selected. Further alternatively, the color-pen function can be displayed.

The data processing device of one embodiment of the present invention enables image synthesis when the color-pen input mode is canceled. For example, in the image synthesis, the annotation data and the image data V1 such as a figure drawn in the color-pen input mode can be synthesized.

### <Structure Example 7 of Data Processing Device>

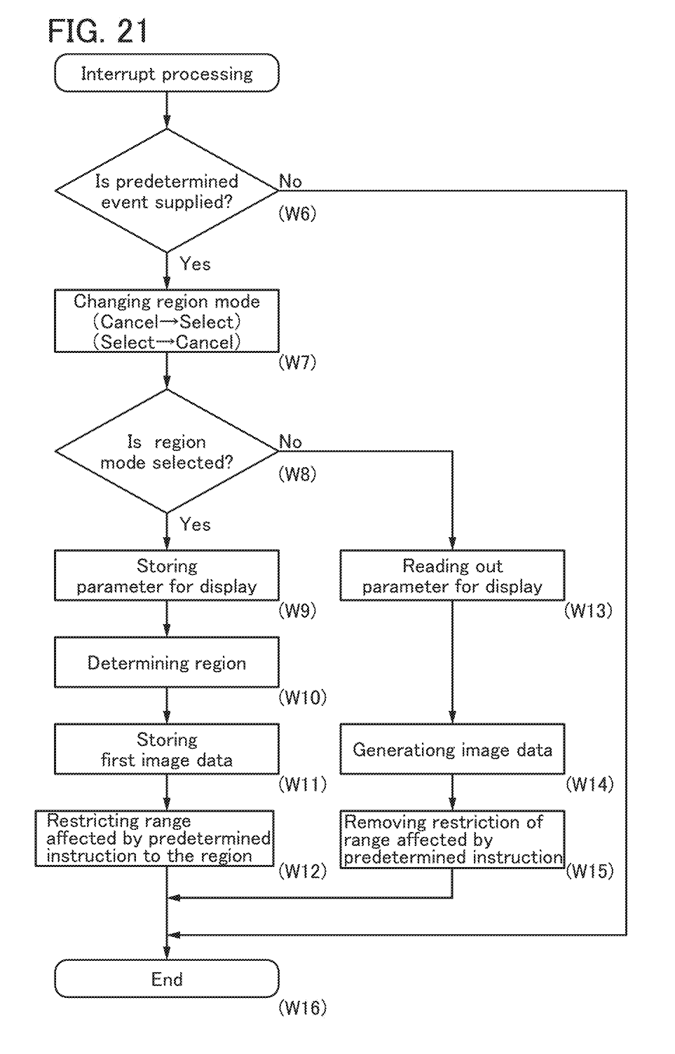

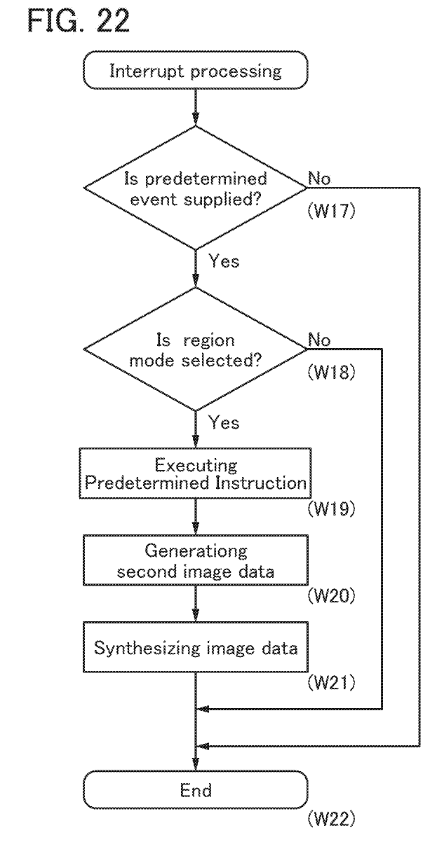

Another structure of the data processing device of one embodiment of the present invention will be described with reference to FIG. 21 and FIG. 22.

FIG. 21 and FIG. 22 are flow charts showing the program of one embodiment of the present invention. The flow chart in FIG. 21 shows interrupt processing different from that in FIG. 14B, and the flow chart in FIG. 22 shows interrupt processing different from that in FIG. 14B or FIG. 21.

Note that the structure example 7 of the data processing device is different from the structure example 1 of the data processing device with reference to FIGS. 14A and 14B in that the different interrupt processing is included. Here, the different portions will be described in detail, and the above description is referred to for the other similar portions.

### <<First Interrupt Processing>>

First interrupt processing includes sixth to sixteenth steps described below (see FIG. 21).

### [Sixth Step]

In the sixth step, the program is determined to proceed to the seventh step when a predetermined event is supplied, whereas the program is determined to proceed to the sixteenth step when the predetermined event is not supplied (see W6 in FIG. 21).

Specifically, an event associated with an instruction for changing a region mode can be used as the predetermined event.

### [Seventh Step]

In the seventh step, a region mode is changed (see W7 in FIG. 21). Specifically, the region mode is selected when the region mode has been canceled, whereas the region mode is canceled when the region mode has been selected.

Note that a state where a range affected by a predetermined instruction is restricted to a predetermined region is referred to as a region mode. In other words, the range affected by a predetermined instruction can be restricted to the predetermined region in the region mode.

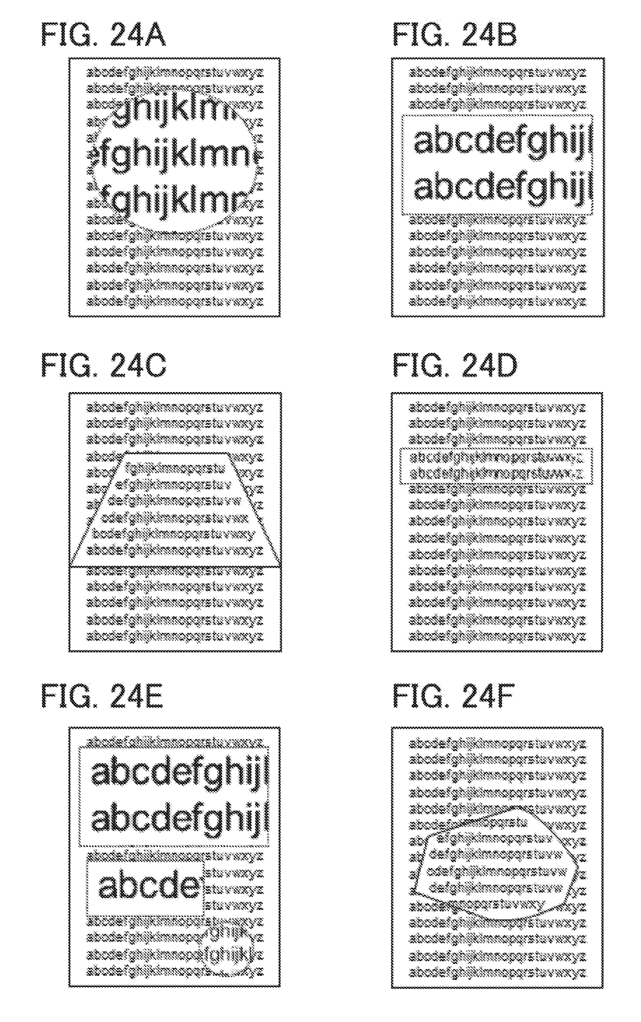

Note that an instruction for changing a parameter for display or the like can be used as the predetermined instruction. Specifically, an instruction for changing a parameter for adjusting a display range, display brightness (see FIG. 24D), color clearness, magnification (enlargement or reduction) of displayed images, or the like can be used for an instruction for changing a parameter for display.

For example, a character string including a portion subjected to a predetermined operation or the like can be enlarged and displayed, and the other portion can be displayed without enlargement (FIGS. 24A, 24B, and 24E). Thus, the object for the predetermined operation can be displayed in a size suitable for the operation. Alternatively, the predetermined operation can be facilitated.

Furthermore, an instruction for editing display data can be used as the predetermined instruction. Specifically, an instruction for adding a supplement, correction, deletion, annotation, or the like can be used for an instruction for editing display data.

Furthermore, an instruction for changing a format of displayed data or the like can be used as the predetermined instruction. Specifically, an instruction for changing a character type, an underline, an italic type, or the like can be used as an instruction for changing a character type.

Furthermore, an instruction for adding a region (see FIG. 24E), an instruction for changing a shape of a region (see FIGS. 24C and 24F), an instruction for changing a position of a region, or the like can be used as the predetermined instruction. Thus, one or a plurality of regions can be selected concurrently. Alternatively, a shape of a region can be changed after the region is selected. Alternatively, the instruction can be prevented from affecting the outside of the region.

### [Eighth Step]

In the eighth step, the program is determined to proceed to the ninth step when the region mode is selected, whereas the program is determined to proceed to the thirteenth step when the region mode is not selected (see W8 in FIG. 21). Specifically, the program proceeds to the thirteenth step when the region mode is canceled.

### [Ninth Step]

In the ninth step, a parameter for display is stored (see W9 in FIG. 21). For example, the parameter for display is stored in the memory portion or the like before the parameter is changed in second interrupt processing. Specifically, a parameter for adjusting a display range, display brightness, color clearness, magnification (enlargement or reduction) of displayed images, or the like is stored. Thus, in the fourteenth step executed when the region mode is canceled, the parameter for display can be returned to a state before the change.

### [Tenth Step]

In the tenth step, a region is determined (see W10 in FIG. 21). For example, positional data or the like is supplied by operation of an input portion by a user of the data processing device, and on the basis of the supplied positional data or the like, a region can be determined. Specifically, the positional data is supplied with use of a touch screen, a pointing device such as a track pad or a mouse, or the like, so that a region can be set.

For example, a trace of the positional data supplied by a pointer can be set in the region. Furthermore, a predetermined figure that can be formed from the trace can be set as the region. For example, a figure inscribed or circumscribed along the trace, specifically, an ellipse, a circle, a polygon, a square, or the like can be used as the predetermined figure.

### [Eleventh Step]

In the eleventh step, the image data V1 is stored (see W11 in FIG. 21). For example, the image data displayed at a time when the region mode is selected can be used as the image data V1.

### [Twelfth Step]

In the twelfth step, a range affected by the predetermined instruction is restricted to the region (see W12 in FIG. 21). Note that the boundary of the region can be included in the range affected by the predetermined instruction. In other words, an instruction to the outside of the region can be canceled. Thus, the range affected by the instruction can be restricted to part of the region, and the instruction can be prevented from affecting the other region.

### [Thirteenth Step]

In the thirteenth step, the parameter for display is read out (see W13 in FIG. 21). Specifically, the parameter for display stored in the ninth step is read out from the memory portion or the like.

### [Fourteenth Step]

In the fourteenth step, image data is generated (see W14 in FIG. 21). Specifically, the parameter for display stored in the ninth step is applied to the image data V2, whereby image data is generated. Note that the parameter for display stored in the ninth step corresponds to a parameter for display of background image data. Thus, it is possible to generate image data affected by an instruction other than the instructions for changing the parameter of display, e.g., the instruction for editing the displayed data or the instruction for chaining a format of the displayed data.

### [Fifteenth Step]

In the fifteenth step, the restriction of the range affected by the predetermined instruction is removed (see W15 in FIG. 21). In other words, the range affected by the predetermined instruction includes all regions.

### [Sixteenth Step]

In the sixteenth step, the first interrupt processing terminates (see W16 in FIG. 21).

### <<Second Interrupt Processing>>

The second interrupt processing includes seventeenth to twenty-second steps described below (see FIG. 22).

### [Seventeenth Step]

In the seventeenth step, the program is determined to proceed to the eighteenth step when a predetermined event is supplied, whereas the program is determined to proceed to the twenty-second step when the predetermined event is not supplied (see W17 in FIG. 22). For example, an event associated with an instruction for affecting a range that is restricted to a predetermined region can be used as the predetermined event.

For example, an event associated with an instruction for chaining a parameter for display, an instruction for editing displayed data, an instruction for changing a format of displayed data, an instruction for adding a region, an instruction for changing a shape of a region, an instruction for changing a position of a region, or the like can be used for the predetermined event.

### [Eighteenth Step]

In the eighteenth step, the program is determined to proceed to the nineteenth step when the region mode is selected, whereas the program is determined to proceed to the twenty-second step when the region mode is not selected (see W18 in FIG. 22). Specifically, the program proceeds to the twenty-second step when the region mode is canceled.

### [Nineteenth Step]

In the nineteenth step, a predetermined instruction associated with the predetermined event is executed (see W19 in FIG. 22).

For example, an instruction for changing a parameter for display, an instruction for editing displayed data, an instruction for changing a format of displayed data, an instruction for adding a region, an instruction for deleting regions other than one region, an instruction for changing a shape of a region, an instruction for changing a position of a region, or the like can be used as the predetermined instruction. Note that effect of the instruction affecting the deleted regions is kept until the regions are deleted. Thus, one or a plurality of regions can be selected concurrently. Alternatively, a shape of a region can be changed after the region is selected. Further alternatively, the instruction can be prevented from affecting the outside of the regions.

### [Twentieth Step]

In the twentieth step, the image data V2 is generated (see W20 in FIG. 22). In other words, the effect of the predetermined instruction associated with the predetermined event is reflected to the image data V2.

### [Twenty-First Step]

In the twenty-first step, a predetermined region of the image data V2 is embedded in a predetermined region of the image data V1, so that image data is synthesized (see W21 in FIG. 22). Specifically, the predetermined region of the image data V2 generated in the twentieth step is embedded in the predetermined region of the image data V1 stored in the eleventh step in the first interrupt processing, so that image data is synthesized. Thus, image data in which the effect of the predetermined instruction is reflected only to the predetermined region can be synthesized.

### [Twenty-Second Step]

In the twenty-second step, the second interrupt processing terminates (see W22 in FIG. 22).

Thus, the data processing device can set a predetermined region on the basis of an event supplied by a user of the data processing device, for example. Alternatively, the data processing device can restrict a range affected by a predetermined instruction to a predetermined region. Alternatively, the data processing device can restrict a range affected by an instruction such as an instruction for changing a parameter for display, an instruction for editing displayed data, or an instruction for changing a format of displayed data to a predetermined region. As a result, a novel method for displaying image data of a data processing device with high convenience or high reliability can be provided.

### <Structure Example 8 of Data Processing Device>

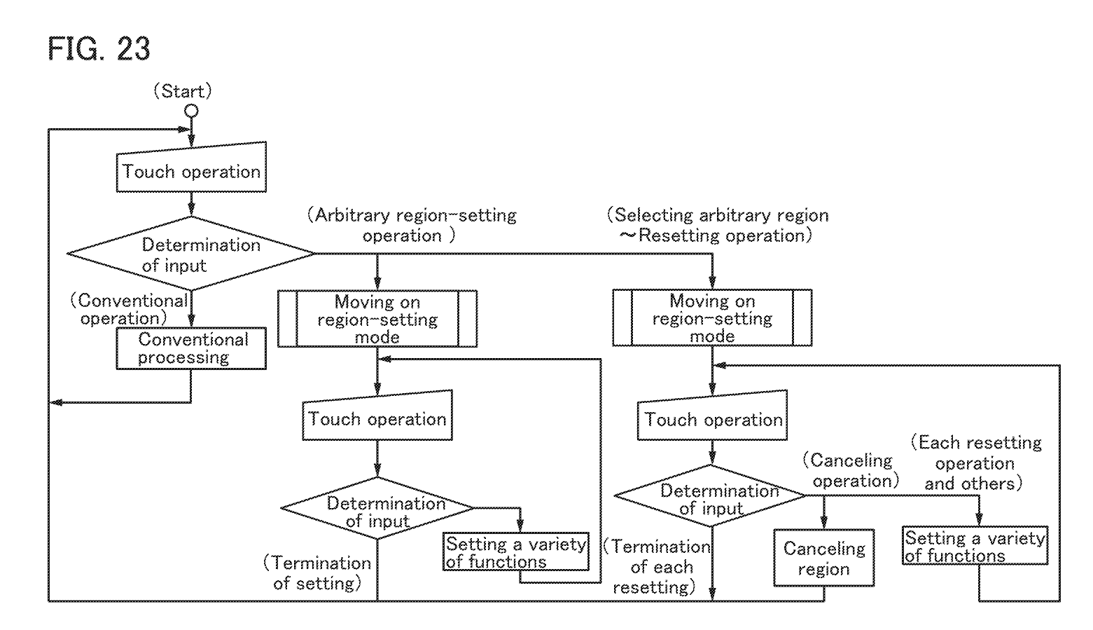

Another structure of the data processing device of one embodiment of the present invention will be described with reference to FIG. 23.

FIG. 23 is a flow chart showing the program of one embodiment of the present invention.

The data processing device includes a first region-setting mode and a second region-setting mode which can be selected on the basis of the operation by a user of the data processing device. When the first region-setting mode is selected, an instruction affecting only an inside of a selected region can be executed. When the second region-setting mode is selected, a region can be newly selected. Alternatively when the second region-setting mode is selected, the selected region is canceled, and a state where a region has not been set can be made. Note that the user can execute a variety of instructions to the selected region. Furthermore, the user can select a plurality of regions (see FIG. 23).

One embodiment of the present invention is a method for displaying image data of a data processing device including main processing and interrupt processing.

The main processing includes a step of allowing the interrupt processing and a step of displaying an image.

The interrupt processing includes a step of selecting the first region-setting mode or the second region-setting mode.

The first region-setting mode includes a step of selecting one or a plurality of regions and a step of setting a display luminance, a display size, or a display position in each region. For example, the display size of image data that is enlarged or reduced and displayed in a display portion can be set in accordance with a parameter.

The second region-setting mode includes a step of selecting one or a plurality of regions, a step of setting a display luminance, a display size, or a display position, a step of setting the shape or size of a region, or a step of canceling the setting.

### <<Region-Setting Mode>>

In the data processing device of one embodiment of the present invention, the program moves on a region-setting mode on the basis of an instruction associated with a predetermined operation.

For example, the predetermined operation can be an operation of moving a pointer at a speed higher than a predetermined value so that a trace of the pointer surrounds one region.

For example, the predetermined operation can be an operation of continuously selecting one point in the one region for a longer period than a predetermined period with use of the pointer.

The data processing device of one embodiment of the present invention in the region-setting mode can restrict a range affected by an instruction associated with the predetermined operation to the selected region.

For example, a range affected by an instruction associated with a touch operation can be restricted.

For example, the following instructions can be associated with the predetermined operation: an instruction for copy or paste; an instruction for zooming in and out a displayed image; an instruction for changing a size of text; an instruction for changing a set parameter; an instruction for changing display brightness; an instruction for changing a shape of a selected region; an instruction for selecting a plurality of regions; an instruction for moving the selected region; an instruction for canceling the selected region; and an instruction for terminating the region-setting mode.

Thus, a user of the data processing device can set a size of brightness or a displayed image, or the like, favorably, per predetermined region. Alternatively, the user can adjust power consumption finely. Further alternatively, the user can see the detailed displayed data easily. Further alternatively, the user can select characters accurately. Further alternatively, the user can select characters smoothly.

This embodiment can be combined with any other embodiment as appropriate.

### Embodiment 5

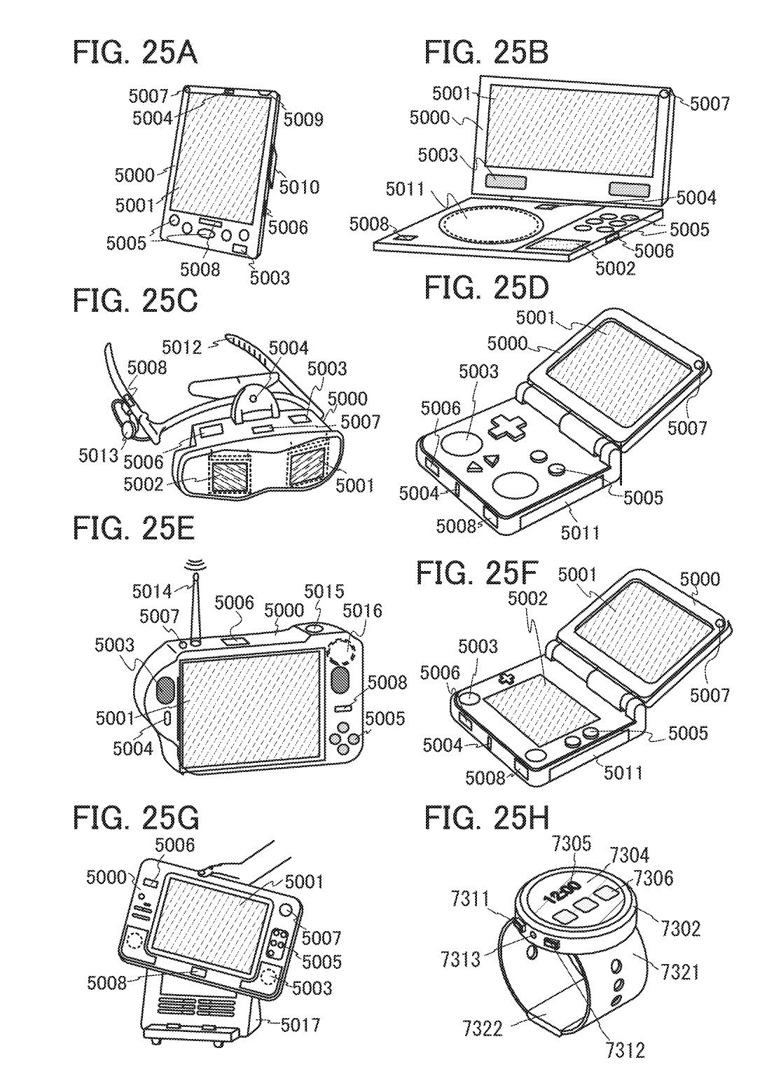

In this embodiment, electronic devices including the data processing device of one embodiment of the present invention will be described with reference to FIGS. 25A to 25H.

FIGS. 25A to 25G illustrate electronic devices. These electronic devices can include a housing 5000, a display portion 5001, a speaker 5003, an LED lamp 5004, operation keys 5005 (including a power switch and an operation switch), a connection terminal 5006, a sensor 5007 (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared ray), a microphone 5008, and the like.

FIG. 25A illustrates a mobile computer that can include a switch 5009, an infrared port 5010, and the like in addition to the above components. FIG. 25B illustrates a portable image reproducing device (e.g., a DVD reproducing device) provided with a recording medium, and the portable image reproducing device can include a second display portion 5002, a recording medium reading portion 5011, and the like in addition to the above components. FIG. 25C illustrates a goggle-type display that can include the second display portion 5002, a support portion 5012, an earphone 5013, and the like in addition to the above components. FIG. 25D illustrates a portable game console that can include the recording medium reading portion 5011 and the like in addition to the above components. FIG. 25E illustrates a digital camera with a television reception function, and the digital camera can include an antenna 5014, a shutter button 5015, an image receiving portion 5016, and the like in addition to the above components. FIG. 25F illustrates a portable game console that can include the second display portion 5002, the recording medium reading portion 5011, and the like in addition to the above components. FIG. 25G illustrates a portable television receiver that can include a charger 5017 capable of transmitting and receiving signals, and the like in addition to the above components.

The electronic devices illustrated in FIGS. 25A to 25G can have a variety of functions. For example, the electronic devices illustrated in FIGS. 25A to 25G can have a variety of functions, for example, a function of displaying a variety of information (a still image, a moving image, a text image, and the like) on the display portion, a touch panel function, a function of displaying a calendar, the date, the time, and the like, a function of controlling processing with a variety of software (programs), a wireless communication function, a function of connecting to a variety of computer networks with a wireless communication function, a function of transmitting and receiving a variety of data with a wireless communication function, and a function of reading a program or data stored in a storage medium and displaying the program or data on the display portion. Furthermore, the electronic device including a plurality of display portions can have a function of displaying image data mainly on one display portion while displaying text data mainly on another display portion, a function of displaying a three-dimensional image by displaying images on a plurality of display portions with a parallax taken into account, or the like. Furthermore, the electronic device including an image receiving portion can have a function of shooting a still image, a function of taking moving images, a function of automatically or manually correcting a shot image, a function of storing a shot image in a recording medium (an external recording medium or a recording medium incorporated in the camera), a function of displaying a shot image on the display portion, or the like. Note that functions of the electronic devices in FIGS. 25A to 25G are not limited thereto, and the electronic devices can have a variety of functions.

FIG. 25H illustrates a smart watch, which includes a housing 7302, a display panel 7304, operation buttons 7311 and 7312, a connection terminal 7313, a band 7321, a clasp 7322, and the like.

The display panel 7304 mounted in the housing 7302 serving as a bezel includes a non-rectangular display region. The display panel 7304 may have a rectangular display region. The display panel 7304 can display an icon 7305 indicating time, another icon 7306, and the like.

The smart watch in FIG. 25H can have a variety of functions such as a function of displaying a variety of data (e.g., a still image, a moving image, and a text image) on the display portion, a touch panel function, a function of displaying a calendar, date, time, and the like, a function of controlling processing with a variety of software (programs), a wireless communication function, a function of being connected to a variety of computer networks with a wireless communication function, a function of transmitting and receiving a variety of data with a wireless communication function, and a function of reading out a program or data stored in a recording medium and displaying it on the display portion.

The housing 7302 can include a speaker, a sensor (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays), a microphone, and the like. Note that the smart watch can be manufactured using the light-emitting element for the display panel 7304.

This embodiment can be combined with any other embodiment as appropriate.

For example, in this specification and the like, an explicit description “X and Y are connected” means that X and Y are electrically connected, X and Y are functionally connected, and X and Y are directly connected. Accordingly, without being limited to a predetermined connection relationship, for example, a connection relationship shown in drawings or texts, another connection relationship is included in the drawings or the texts.

Here, each of X and Y denotes an object (e.g., a device, an element, a circuit, a wiring, an electrode, a terminal, a conductive film, or a layer).

Examples of the case where X and Y are directly connected include the case where an element that enables electrical connection between X and Y (e.g., a switch, a transistor, a capacitor, an inductor, a resistor, a diode, a display element, a light-emitting element, or a load) is not connected between X and Y, and the case where X and Y are connected without the element that enables electrical connection between X and Y provided therebetween.

For example, in the case where X and Y are electrically connected, one or more elements that enable electrical connection between X and Y (e.g., a switch, a transistor, a capacitor, an inductor, a resistor, a diode, a display element, a light-emitting element, or a load) can be connected between X and Y. Note that the switch is controlled to be turned on or off. That is, the switch is conducting or not conducting (is turned on or off) to determine whether current flows therethrough or not. Alternatively, the switch has a function of selecting and changing a current path. Note that the case where X and Y are electrically connected includes the case where X and Y are directly connected.

For example, in the case where X and Y are functionally connected, one or more circuits that enable functional connection between X and Y (e.g., a logic circuit such as an inverter, a NAND circuit, or a NOR circuit; a signal converter circuit such as a DA converter circuit, an AD converter circuit, or a gamma correction circuit; a potential level converter circuit such as a power supply circuit (e.g., a step-up circuit or a step-down circuit) or a level shifter circuit for changing the potential level of a signal; a voltage source; a current source; a switching circuit; an amplifier circuit such as a circuit capable of increasing signal amplitude, the amount of current, or the like, an operational amplifier, a differential amplifier circuit, a source follower circuit, and a buffer circuit; a signal generator circuit; a memory circuit; and/or a control circuit) can be connected between X and Y. Note that for example, in the case where a signal output from X is transmitted to Y even when another circuit is provided between X and Y, X and Y are functionally connected. The case where X and Y are functionally connected includes the case where X and Y are directly connected and X and Y are electrically connected.

Note that in this specification and the like, an explicit description “X and Y are electrically connected” means that X and Y are electrically connected (i.e., the case where X and Y are connected with another element or another circuit provided therebetween), X and Y are functionally connected (i.e., the case where X and Y are functionally connected with another circuit provided therebetween), and X and Y are directly connected (i.e., the case where X and Y are connected without another element or another circuit provided therebetween). That is, in this specification and the like, the explicit description “X and Y are electrically connected” is the same as the explicit description “X and Y are connected.”

For example, any of the following expressions can be used for the case where a source (or a first terminal or the like) of a transistor is electrically connected to X through (or not through) Z1 and a drain (or a second terminal or the like) of the transistor is electrically connected to Y through (or not through) Z2, or the case where a source (or a first terminal or the like) of a transistor is directly connected to one part of Z1 and another part of Z1 is directly connected to X while a drain (or a second terminal or the like) of the transistor is directly connected to one part of Z2 and another part of Z2 is directly connected to Y.

Examples of the expressions include, “X Y, a source (or a first terminal or the like) of a transistor, and a drain (or a second terminal or the like) of the transistor are electrically connected to each other, and X, the source (or the first terminal or the like) of the transistor, the drain (or the second terminal or the like) of the transistor, and Y are electrically connected to each other in this order”, “a source (or a first terminal or the like) of a transistor is electrically connected to X, a drain (or a second terminal or the like) of the transistor is electrically connected to Y, and X, the source (or the first terminal or the like) of the transistor, the drain (or the second terminal or the like) of the transistor, and Y are electrically connected to each other in this order”, and “X is electrically connected to Y through a source (or a first terminal or the like) and a drain (or a second terminal or the like) of a transistor, and X, the source (or the first terminal or the like) of the transistor, the drain (or the second terminal or the like) of the transistor, and Y are provided to be connected in this order”. When the connection order in a circuit configuration is defined by an expression similar to the above examples, a source (or a first terminal or the like) and a drain (or a second terminal or the like) of a transistor can be distinguished from each other to specify the technical scope.

Other examples of the expressions include, “a source (or a first terminal or the like) of a transistor is electrically connected to X through at least a first connection path, the first connection path does not include a second connection path, the second connection path is a path between the source (or the first terminal or the like) of the transistor and a drain (or a second terminal or the like) of the transistor, Z1 is on the first connection path, the drain (or the second terminal or the like) of the transistor is electrically connected to Y through at least a third connection path, the third connection path does not include the second connection path, and Z2 is on the third connection path” and “a source (or a first terminal or the like) of a transistor is electrically connected to X at least with a first connection path through Z1, the first connection path does not include a second connection path, the second connection path includes a connection path through which the transistor is provided, a drain (or a second terminal or the like) of the transistor is electrically connected to Y at least with a third connection path through Z2, and the third connection path does not include the second connection path”. Still another example of the expression is “a source (or a first terminal or the like) of a transistor is electrically connected to X through at least Z1 on a first electrical path, the first electrical path does not include a second electrical path, the second electrical path is an electrical path from the source (or the first terminal or the like) of the transistor to a drain (or a second terminal or the like) of the transistor, the drain (or the second terminal or the like) of the transistor is electrically connected to Y through at least Z2 on a third electrical path, the third electrical path does not include a fourth electrical path, and the fourth electrical path is an electrical path from the drain (or the second terminal or the like) of the transistor to the source (or the first terminal or the like) of the transistor”. When the connection path in a circuit configuration is defined by an expression similar to the above examples, a source (or a first terminal or the like) and a drain (or a second terminal or the like) of a transistor can be distinguished from each other to specify the technical scope.

Note that these expressions are examples and there is no limitation on the expressions. Here, X, Y, Z1, and Z2 each denote an object (e.g., a device, an element, a circuit, a wiring, an electrode, a terminal, a conductive film, or a layer).

Even when independent components are electrically connected to each other in a circuit diagram, one component has functions of a plurality of components in some cases. For example, when part of a wiring also functions as an electrode, one conductive film functions as the wiring and the electrode. Thus, the term “electrical connection” in this specification also means such a case where one conductive film has functions of a plurality of components.

### EXPLANATION OF REFERENCE

BM: light-blocking film, SD: driver circuit, GD: driver circuit, GDA: driver circuit, GDB: driver circuit, CP: conductive material, ML(h): signal line, ANO: conductive film, BR(g,h): conductive film, SS: control data, C(g): electrode, M(h): electrode, CSCOM: wiring, ACF1: conductive material, ACF2: conductive material, AF1: alignment film, AF2: alignment film, C11: capacitor, C12: capacitor, CF1: coloring film, CF2: coloring film, G1(i): scan line, G2(i): scan line, KB1: structure body, S1(j): signal line, S2(j): signal line, SD1: driver circuit, SD2: driver circuit, SW1: switch, SW2: switch, V1: image data, V2: image data including annotation data, V11: data, V12: data, V13: data, VCOM1: wiring, VCOM2: conductive film, FPC1: flexible printed circuit, FPC2: flexible printed circuit, 220: input/output device, 230: display portion, 231: display region, 234: decompression circuit, 235M: image processing circuit, 238: control portion, 240: input portion, 241: sensor region, 501A: insulating film, 501C: insulating film, 504: conductive film, 505: bonding layer, 506: insulating film, 508: semiconductor film, 508A: region, 508B: region, 508C: region, 511B: conductive film, 511C: conductive film, 511D: conductive film, 512A: conductive film, 512B: conductive film, 516: insulating film, 518: insulating film, 519B: terminal, 519C: terminal, 519D: terminal, 520: functional layer, 521: insulating film, 522: connection portion, 524: conductive film, 528: insulating film, 530(i,j): pixel circuit, 550(i,j): display element, 551: electrode, 552: electrode, 553(j): layer containing light-emitting material, 570: substrate, 591A: opening, 591B: opening, 591C: opening, 592A: opening, 592B: opening, 592C: opening, 700: display panel, 700B: display panel, 700TP2: input/output panel, 702(i,j): pixel, 705: sealant, 706: insulating film, 719: terminal, 720: functional layer, 750(i,j): display element, 751: electrode, 751E: region, 751H: opening, 752: electrode, 753: layer containing liquid crystal material, 754A: intermediate film, 754B: intermediate film, 754C: intermediate film, 754D: intermediate film, 770: substrate, 770D: functional film, 770P: functional film, 771: insulating film, 775: sensor element, 5000: housing, 5001: display portion, 5002: display portion, 5003: speaker, 5004: LED lamp, 5005: operation key, 5006: connection terminal, 5007: sensor, 5008: microphone, 5009: switch, 5010: infrared port, 5011: recording medium reading portion, 5012: support portion, 5013: earphone, 5014: antenna, 5015: shutter button, 5016: image receiving portion, 5017: charger, 7302: housing, 7304: display panel, 7305: icon, 7306: icon, 7311: operation button, 7312: operation button, 7313: connection terminal, 7321: band, 7322: clasp

This application is based on Japanese Patent Application serial no. 2016-090847 filed with Japan Patent Office on Apr. 28, 2016, Japanese Patent Application serial no. 2016-090848 filed with Japan Patent Office on Apr. 28, 2016, and Japanese Patent Application serial no. 2016-095071 filed with Japan Patent Office on May 11, 2016, the entire contents of which are hereby incorporated by reference.

1. A display device comprising:
a display panel comprising a pixel, the pixel comprising a first display element and a second display element; and
a control portion,
wherein the control portion is configured to receive an image data and a control data,
wherein the control portion is configured to generate a first data on the basis of the image data,
wherein the control portion is configured to generate a second data on the basis of the image data,
wherein the control portion is configured to detect a contour portion from the image data and to generate a third data in which the contour portion is emphasized,
wherein the control portion is configured to supply the first to third data,
wherein the display panel is configured to receive the first to third data,
wherein the first display element is configured to display an image on the basis of the first data, and
wherein the second display element is configured to display an image on the basis of the second or third data.

2. The display device according to claim 1,
wherein the first display element is a reflective display element, and
wherein the second display element is a light-emitting element.

3. The display device according to claim 1,
wherein the pixel further comprises:
a first conductive film;
a second conductive film;
an insulating film; and
a pixel circuit,
wherein the second conductive film comprises a region overlapping with the first conductive film,
wherein the insulating film comprises a region between the first conductive film and the second conductive film,
wherein the insulating film comprises an opening,
wherein the second conductive film is electrically connected to the first conductive film in the opening,
wherein the second conductive film is electrically connected to the pixel circuit,
wherein the first conductive film is electrically connected to the first display element,
wherein the second display element is electrically connected to the pixel circuit,
wherein the second display element is configured to emit light toward the insulating film, and
wherein the second display element is located so that an image displayed using the second display element is seen in a part of a range where an image displayed using the first display element is seen.

4. The display device according to claim 1,
wherein the display panel comprises:
one group of a plurality of pixels;
another group of a plurality of pixels;
a signal line; and
a scan line,
wherein the one group of a plurality of pixels comprise the pixel;
wherein the one group of a plurality of pixels are arranged in a row direction,
wherein the another group of a plurality of pixels comprise the pixel,
wherein the another group of a plurality of pixels are arranged in a column direction intersecting the row direction,
wherein the scan line is electrically connected to the one group of a plurality of pixels, and
wherein the signal line is electrically connected to the another group of a plurality of pixels.

5. An input/output device comprising:
the display device according to claim 1; and
an input portion,
wherein the input portion is configured to sense an object approaching a region overlapping with the display panel.

6. The input/output device according to claim 5,
wherein the input portion comprises a region overlapping with the display panel,
wherein the input portion comprises:
a control line;
a sensor signal line; and
a sensor element,
wherein the control line is configured to supply a control signal,
wherein the sensor signal line is configured to receive a sensor signal,
wherein the sensor element is electrically connected to the control line and the sensor signal line,
wherein the sensor element has a light-transmitting property,
wherein the sensor element comprises a first electrode and a second electrode,
wherein the first electrode is electrically connected to the control line,
wherein the second electrode is electrically connected to the sensor signal line,
wherein the second electrode is located so that an electric field part of which is blocked by the object approaching the region overlapping with the display panel is generated between the second electrode and the first electrode, and
wherein the sensor element is configured to supply the sensor signal that changes depending on the control signal and a distance between the sensor element and the object approaching the region overlapping with the display panel.

7. A data processing device comprising:
an input/output device; and
an arithmetic device,
wherein the input/output device comprises an input portion and an output portion,
wherein the output portion comprises the display device according to claim 1,
wherein the input portion is configured to supply a positional data,
wherein the arithmetic device is configured to supply the image data,
wherein the arithmetic device is configured to supply a control signal on the basis of the positional data, and
wherein the control portion is configured to generate the first, second, and third data on the basis of the control signal.

8. A data processing device comprising:
at least one of a keyboard, a hardware button, a pointing device, a touch sensor, an illuminance sensor, an imaging device, an audio input device, a viewpoint input device, and a posture determination device; and
the display device according to claim 1.

9. A display device comprising:
a display panel comprising a pixel, the pixel comprising a first display element and a second display element; and
a control portion,
wherein the control portion is configured to receive an image data,
wherein the control portion is configured to generate a first data based on the image data,
wherein the control portion is configured to generate a second data based on the image data,
wherein the control portion is configured to detect a contour portion from the image data and to generate a third data in which the contour portion is emphasized,
wherein the control portion is configured to supply the first to third data,
wherein the display panel is configured to receive the first to third data,
wherein the first display element is configured to display an image based on the first data, and
wherein the second display element is configured to display an image based on at least one of the second data and the third data.

10. The display device according to claim 9,
wherein the first display element is a reflective display element, and
wherein the second display element is a light-emitting element.

11. The display device according to claim 9,
wherein the pixel further comprises:
a first conductive film;
a second conductive film;
an insulating film; and
a pixel circuit,
wherein the second conductive film comprises a region overlapping with the first conductive film,
wherein the insulating film comprises a region between the first conductive film and the second conductive film,
wherein the insulating film comprises an opening,
wherein the second conductive film is electrically connected to the first conductive film in the opening,
wherein the second conductive film is electrically connected to the pixel circuit,
wherein the first conductive film is electrically connected to the first display element,
wherein the second display element is electrically connected to the pixel circuit,
wherein the second display element is configured to emit light toward the insulating film, and
wherein the second display element is located so that an image displayed using the second display element is seen in a part of a range where an image displayed using the first display element is seen.

12. The display device according to claim 9,
wherein the display panel comprises:
one group of a plurality of pixels;
another group of a plurality of pixels;
a signal line; and
a scan line,
wherein the one group of a plurality of pixels comprise the pixel;
wherein the one group of a plurality of pixels are arranged in a row direction,
wherein the another group of a plurality of pixels comprise the pixel,
wherein the another group of a plurality of pixels are arranged in a column direction intersecting the row direction,
wherein the scan line is electrically connected to the one group of a plurality of pixels, and
wherein the signal line is electrically connected to the another group of a plurality of pixels.

13. An input/output device comprising:
the display device according to claim 9; and
an input portion,
wherein the input portion is configured to sense an object approaching a region overlapping with the display panel.

14. The input/output device according to claim 13,
wherein the input portion comprises a region overlapping with the display panel,
wherein the input portion comprises:
a control line;
a sensor signal line; and
a sensor element,
wherein the control line is configured to supply a control signal,
wherein the sensor signal line is configured to receive a sensor signal,
wherein the sensor element is electrically connected to the control line and the sensor signal line,
wherein the sensor element has a light-transmitting property,
wherein the sensor element comprises a first electrode and a second electrode,
wherein the first electrode is electrically connected to the control line,
wherein the second electrode is electrically connected to the sensor signal line,
wherein the second electrode is located so that an electric field part of which is blocked by the object approaching the region overlapping with the display panel is generated between the second electrode and the first electrode, and
wherein the sensor element is configured to supply the sensor signal that changes depending on the control signal and a distance between the sensor element and the object approaching the region overlapping with the display panel.

15. A data processing device comprising:
an input/output device; and
an arithmetic device,
wherein the input/output device comprises an input portion and an output portion,
wherein the output portion comprises the display device according to claim 9,
wherein the input portion is configured to supply a positional data,
wherein the arithmetic device is configured to supply the image data,
wherein the arithmetic device is configured to supply a control signal on the basis of the positional data, and
wherein the control portion is configured to generate the first, second, and third data on the basis of the control signal.

16. A data processing device comprising:
at least one of a keyboard, a hardware button, a pointing device, a touch sensor, an illuminance sensor, an imaging device, an audio input device, a viewpoint input device, and a posture determination device; and
the display device according to claim 9.

17. A display method of an image data of a data processing device, comprising:
a main processing; and
an interrupt processing,
wherein the main processing comprises a first step to a fifth step,
wherein in the first step, a setting is initialized,
wherein in the second step, the interrupt processing is allowed,
wherein in the third step, an image is displayed with use of a display method selected in the first step or the interrupt processing,
wherein in the fourth step, the main processing is determined to proceed to the fifth step when a termination instruction is supplied, and the main processing is determined to proceed to the third step when the termination instruction is not supplied,
wherein in the fifth step, the main processing terminates,
wherein the interrupt processing comprises a sixth step to a fourteenth step,
wherein in the sixth step, a display method is selected,
wherein in the seventh step, the interrupt processing is determined to proceed to the eighth step when a first display method is displayed, and the interrupt processing is determined to proceed to the ninth step when the first display method is not selected,
wherein in the eighth step, a second data is generated on the basis of an image data and the interrupt processing proceeds to the thirteenth step,
wherein in the ninth step, a first data is generated on the basis of the image data,
wherein in the tenth step, the interrupt processing is determined to proceed to the eleventh step when a second display method is selected, and the interrupt processing is determined to proceed to the thirteenth step when the second display method is not selected,
wherein in the eleventh step, a contour portion is detected from the image data,
wherein in the twelfth step, a third data in which the contour portion is emphasized is generated,
wherein in the thirteenth step, the generated data is supplied, and
wherein in the fourteenth step, the interrupt processing terminates.
